(19) United States
(12) Patent Application Publication
(10) Pub. No.: US 2014/0052877 A1
(43) Pub. Date: Feb. 20, 2014

(54) Method and apparatus for tenant programmable logical network for multi-tenancy cloud datacenters

(71) Applicant: Wenbo Mao, Beijing (CN)

(72) Inventor: Wenbo Mao, Beijing (CN)

(21) Appl. No.: 13/968,511

(22) Filed: Aug. 16, 2013

Related U.S. Application Data
(60) Provisional application No. 61/683,866, filed on Aug. 16, 2012.

(51) Int. Cl. H04L 29/12

(52) U.S. Cl. CPC H04L 61/20
USPC 709/245

(57) ABSTRACT

Conventional network technology is based on processing metadata in the head part of a network packet (e.g., addresses and context tags). In cloud computing, resources have dynamic properties of on-demand elasticity, trans-datacenter distribution, location motion, and tenant-defining arbitrary network topology. Conventional static networks can no longer satisfy these dynamic properties of IT provisioning. Provided is a network virtualization technology—“NVI”. The NVI technology achieves de-coupling between a logical network and the underlying physical network provided through cloud resources. Network control can be implemented on vNICs of VMs in the network. On NVI, a cloud tenant can construct a firewalled logic and virtual private network to protect rental IT infrastructure in global trans-datacenter distributions. The de-coupling enables the virtual network construction job to be completed as high-level language programming tasks (SDN), achieving cloud properties of automatic, fast, dynamic changing, unlimited size scalability, and tenant-defining arbitrary topology network provisioning.

### RELATED APPLICATIONS

This application claims priority under 35 U.S.C. §119(e) to U.S. Provisional Application Ser. No. 61/683,866 entitled “METHOD AND APPARATUS FOR TENANT PROGRAMMABLE TRUSTED NETWORK FOR TRUSTED MULTI-TENANCY CLOUD DATACENTERS,” filed Aug. 16, 2012, which application is incorporated herein by reference in their entirety.

### BACKGROUND

Currently there are a number of cloud compute providers who rent resources for executing computer based tasks. For example, Amazon Web Services (AWS, aws.amazon.com) and Google App Engine (developers.google.com/appengine) provide public clouds, and allow for rental of resources within their respective clouds. These providers make available some privatization of network resources, for example, through virtual private network (VPN)-based isolation of LAN for their tenants (see e.g., FIG. 1). For example, the VPN-based LAN isolation technology includes “Virtual Private Cloud (VPC)” (e.g., aws.amazon.com/vpc/) and VLANs. As illustrated in FIG. 1, the VPN-based LAN isolation technology demands that the tenant maintain an onsite legacy infrastructure to play the role of a VPN master site, configuring the offsite VPC part of the VPN in the cloud as a slave site. Additional problems with VPN-based LAN isolation technology include that the network resource a tenant can obtain from a cloud datacenter is not virtualized, not software defined, and hence does not have cloud features of on-demand programmability for elastic scalability or cross-datacenter distribution.

In some conventional approaches, the well-known “Classless Inter-Domain Routing (CIDR)” technology (see e.g., en.wikipedia.org/wiki/CIDR) is used by an onsite main LAN infrastructure to configure the offsite part of the VPN in the cloud as a subnet (subLAN) of the onsite LAN. Because a subnet LAN's external facing communications are enabled by, and exclusively routed via, the main LAN, as long as the onsite main LAN is configured to isolate itself from a given network (e.g., from the cloud datacenter which hosts its VPC sub-net), so is the VPC sub-net. Indeed, the offsite VPC hosted in the cloud is a communication cul-de-sac, such that all the external facing communications of the nodes in the offsite VPC must be re-routed via the onsite legacy infrastructure.

Other conventional approaches to cloud based network isolation include configuring separate VLANs with dedicated network equipment such as hardware switches, routers and dedicated servers and the related software components running on them. VLAN technologies can employ tagging and tunneling methods to partition a LAN into logically segmented VLANs. Switches (in software or hardware) and routers (in software or hardware) can individually tag, and then tunnel according to different tags and/or network packets for different tenants. Network packets belonging to different tenants are tagged with distinct tags and thus can be tunneled separately, although these packets all flow through the shared hardware LAN infrastructure.

More recent implementations, e.g., OpenFlow (openflow.org) (See FIG. 3) and OpenvSwitch (openvswitch.org) projects focus on programmability and automatic configurability of the LAN inside one datacenter, and VXLAN, NVGRE, TRILL, STT, etc., technologies, focus on constructing datacenter LAN infrastructure at a large scale (e.g., to solve the well-known 4K problem in the current VLAN technology, amongst many other scalability problems). These approaches attempt to build a large scale network, even one which can have a trans-datacenter distribution and scale to suit cloud uses. These network enlargement technologies all use protocol negotiations among switches, software- and/or hardware-implemented ones, in order to build a big logical switch. These technologies of protocol negotiations are based on the following simple principle: a network (let us begin the protocol description with the smallest size: a local area network LAN), is defined by a switch; if a network is not large enough, then patching two or more switches together can define a larger sized network; the more number of switches are patched, the larger a network is constructed, . . . , until the resultant network reaches a limit size which is limited by the number of bits in the network address allowed by the switches participating the patching game (protocol). If one still wants to build an even larger network, then a router is needed to link (patch) two networks of patched switches, and the patching game (protocol) does on. To this end it is easy to understand that these network patching technologies are a step-by-step process to grow a network.

### SUMMARY

It is realized that conventional approaches are not efficient, and are not programmable by a cloud tenant even within one datacenter, are not easily programmable even by a cloud provider, for example, where the network patching game goes beyond a single cloud provider. It is further realized that the industry for cloud IT is still without a standardized cloud network technology which can be easily interoperable among different cloud providers. It is further realized that conventional VPN and VLAN network isolation is still modeled on underlying physical network architectures. Conventional network models do not leverage the cloud based nature of the environment to provide network isolation and dynamic resource allocation according to a cloud based model. Conventional VPN-based network isolation is more like a hybrid cloud scenario in which the offsite part (the cloud portion) only plays the role of a backup site. As a result, the tenant still has to own and maintain expensive hardware (e.g., “IT as an asset”). Such implementations can require hardware having the same capacity as if it was hosted onsite (even by ignoring the communication degradation in the WAN leg), limiting any potential savings in spend related maintenance and/or IT-personnel costs.

For example, conventional VLAN isolation requires significant overhead, expensive hardware, The VLAN is also configured for centralized operation of control (processing of addressing metadata in the head part of a packet) and data flow forwarding (processing of the application data in the rest of the packet) which can further add difficulties to implementing programmability of cloud network infrastructure by requiring processing of metadata (e.g., tag addressing) and application data flow at a single central point. The central process leads to bottlenecks and/or a single chokepoint through which all communication must flow. It is further realized that conventional approaches to providing networking services and/or IaaS via cloud compute models suffer from many drawbacks. Even in many so-called virtualized networking implementations, virtual network topology is still constrained by physical networking models, and in particular, single chokepoint modeling. Accordingly, some aspects and embodiments provide solutions for a logical networking architecture implemented in a cloud compute space. In some embodiments, the logical network architecture can bridge multiple cloud service providers to create a virtual topology separate from any physical architecture constraints.

As discussed herein, various aspects and embodiments solve for issues associated with conventional approaches using globally distributed and intelligent network virtualization infrastructure (“NVI”). The NVI is configured to provide communication functions to a group of virtual machines (VMs), which in some examples, can be distributed across a plurality of dataclouds or cloud providers. The NVI implements a logical network between the VMs enabling intelligent virtualization and programmable configuration of the logical network. The NVI can include software components (including, for example, hypervisors (i.e. VM managers)) and database management systems (DBMS) configured to manage network control functions.

According to one aspect, the NVI manages communication between a plurality of virtual machines by managing physical communication pathways between a plurality of physically associated network addresses which are mapped to respective globally unique logical identities of the respective plurality of virtual machines. According to another aspect, network control is implemented on vNICs of VMs within the logical network. The NVI can direct communication on the logical network according to mappings between logical addresses (e.g., assigned at vNICs for VMs) of VMs and physically associated addresses assign by respective clouds with the mappings being stored by the DBMS. The mappings can be updated, for example, as VMs change location. For example, a logical address can be remapped to a new physically associated address when a virtual machine changes physical location with the new physically associated address being recorded in the DBMS to replace the previous physically associated address before the VM changing physical location. According to one embodiment, the network control is fully logical enabling the network dataflow for the logical network to continue over the physical networking components (e.g., assigned by cloud providers) that are mapped to and underlie the logical network.

According to some embodiments, enabling the network control functions directly at vNICs of respective VMs provides for definition and/or management of arbitrarily scalable virtual or logical networks. Such control functions can be action of “plugging”/“unplugging” logically defined unicast cables between vNICs of pairs of VMs to implement network isolations policy, transform formats for network packets (e.g., between IPv6-IPv4 packets), provide cryptographic services on applications data in network packets to implement cryptographic protection on tenants' data, monitor and/or manage traffic to implement advanced network QoS (e.g., balance load, divert traffic, etc.), provide intrusion detection and/or resolution to implement network security QoS, allocate expenses to tenants based on network utilization, among other options. In some example implementations, such logical networks can target a variety of quality of service goals. Some example goals include providing a cloud datacenter configured to operate in resource rental, multi-tenancy, and in some preferred embodiments, Trusted Multi-tenancy, and in further preferred embodiments, on-demand and self-serviceable manners.

In some implementations, resource rental refers to a tenant (e.g., an organization or for compute project), who rents a plural number of virtual machines (VMs) for its users (e.g., employees of the tenant) for computations the tenant wishes to execute. The users, applications, and/or processes of the tenant use the compute resources of a provider through the rental VMs, which can include operating systems, databases, web/mail services, applications, and other software resources installed on the VMs.

In some implementations, multi-tenancy refers to a cloud datacenter or cloud compute provider that is configured to serve a plural number of tenants. The multi-tenancy model is conventional throughout compute providers, which typically allows the datacenter to operate with economy of scale. In further implementations, multi-tenancy can be extended to trusted multi-tenancy, where VMs and associated network resources are isolated from accessing by the system operators of the cloud providers, and unless with explicitly instructed permission(s) from the tenants involved, any two VMs and associated network resources which are rented by different tenants respectively are configured to be isolated from one another. VMs and associated network resources which are rented by one tenant can be configured to communicate with one another according to any security policy set by the tenant.

In some embodiments, on-demand and self-serviceability refers to the ability of a tenant to rent a dynamically changeable quantity/amount/volume of resources according to need, and in preferred embodiment, in a self-servicing manner (e.g., by editing a restaurant menu like webpage). In one example, self-servicing can include instructing the datacenter using simple web-service-like interfaces for resource rental at a location outside the datacenter. In some embodiments, self-servicing resource rental can include a tenant renting resourced from a plural number of cloud providers which have trans-datacenter physical and/or geographical distributions. It is realized that the convention cloud datacenters or compute providers only satisfy at best the above desirable cloud properties with respect to rental resources for CPU, Memory, and Storage. Conventional approaches may fail to provide any one or more of: multi-tenancy, trusted multi-tenancy, on-demand, trans-datacenter resource rental and self serviceability with respect to network resources, and for example with respect to Local Area Network (LAN). LAN is typically a shared hardware resource in a datacenter. For IT security, (e.g., cloud security), isolation of LAN in cloud datacenters for tenants, can be necessary. However, it is realized that LAN isolation turns out to be a very challenging task unresolved by conventional approaches.

Accordingly, provided are systems and methods for isolating network resources within cloud compute environments. According to some embodiments, the systems and methods provide logical de-coupling of a tenant network through globally uniquely identifiable identities assigned to VMs. Virtualization infrastructure (VI) at each provider can be configured to manage communication over a logical virtual network created via the global identifiers for VMs rented by the tenant. The logical virtual network can be configured to extend past cloud provider boundaries, and in some embodiments, allows a tenant to specify the VMs and associated logical virtual network (located at any provider) via whitelist definition.

According to one aspect, a system for managing a logical network operating in a cloud compute environment is provided. The system comprises at least one processor operatively connected to a memory, a network virtualization infrastructure (NVI) component, executed by the at least one processor, configured to manage communication between a plurality of virtual machine, assign globally unique logical identities to the plurality of virtual machines, map, for each virtual machine, a respective globally unique logical identity to a physically associated network address, and control communication within the logical network according to the globally unique logical identities.

According to one embodiment, the NVI component is configured to map between the globally unique logical identities of the virtual machines having respective physically associated network addresses. According to one embodiment, the NVI component is configured to control communication within the logical network according to the globally unique logical identities at respective virtual network interface controllers (“vNICs”) of the plurality of virtual machines.

According to one embodiment, the NVI component is configured to define logically unicast cables between pairs of vNICs of the plurality of virtual machines according to their globally unique logical identities. According to one embodiment, the system further comprises a database management system (DBMS) configured to store mappings between the globally unique logical identities of the plurality of virtual machines and physically associated addresses.

According to one embodiment, the NVI component is configured to update a respective mapping stored by the DBMS between the globally unique logical identity and the physically associated network address in response to migration of a VM to a new location which has a new physically associated network address. According to one embodiment, the NVI component includes a plurality of hypervisors configured to control communication between the plurality of virtual machines according to mappings accessible through the DBMS. According to one embodiment, NVI component includes a plurality of hypervisors and DBMS associated with at least one or a plurality of cloud providers.

According to one embodiment, the plurality of hypervisors are configured to: assign resources from respective cloud providers, wherein the plurality of hypervisors assign physically associated addresses for the resources; and maintain mappings between the globally unique logical identities of the plurality of virtual machines and the physically associated addresses. According to one embodiment, the system comprises a network definition component configured to accept specification of a group of virtual machines to include in a tenant logical network.

According to one embodiment, the network definition component is configured to accept tenant specified definition of the group of virtual machines, wherein tenant specified definition includes identifying information for the group of virtual machines to be included in the tenant logical network. According to one embodiment, the NVI component is configured to define an exclusive communication channel over a logical unicast cable for each pair of virtual machines of the plurality of virtual machines. According to one embodiment, the NVI component is configured to activate or de-activate the exclusive communication channel between the pair of virtual machines.

According to one embodiment, the NVI component is configured to activate or de-activate the exclusive communication channel according to tenant defined communication policy. According to one embodiment, the tenant defined communication policy includes criteria for allowing or excluding communication over respective exclusive communication channels. According to one embodiment, the NVI component is configured to control external communication with the plurality of virtual machines at respective vNICs of the plurality of virtual machines. According to one embodiment, a system accessible communication policy can specify communication criteria for external communication.

According to one embodiment, the NVI component is configured to manage communication between a plurality of virtual machines by managing physical communication pathways between a plurality of physically associated network addresses which are mapped to respective globally unique logical identities of the respective plurality of virtual machines, According to one embodiment, the mapping between the globally unique logical identities of the virtual machines and physically associated network addresses is configured to use physical network addresses of the NVI.

According to one embodiment, the NVI component includes a plurality of hypervisors and respective proxy entities, wherein the plurality of hypervisors and the respective proxy entities are configured to manage the communication between the plurality of virtual machines.

According to one embodiment, the respective proxy entities are configured to maintain mappings between the globally unique logical identities of the plurality of virtual machines and the physically associated addresses.

According to one aspect, a computer implemented method for managing a logical network operating in a cloud compute environment is provided. The method comprising managing, by a computer system, communication between a plurality of virtual machines, assigning, by the computer system, globally unique logical identities to the plurality of virtual machines, mapping, by the computer system, for each virtual machine, a respective globally unique logical identity to a physically associated network address, and controlling, by the computer system, communication within the logical network according to the globally unique logical identities.

According to one embodiment, controlling communication within the logical network according to the globally unique logical identities includes controlling communication at respective virtual network interface controllers (“vNICs”) of the plurality of virtual machines. According to one embodiment, the method further comprises defining logically unicast cables between pairs of vNICs of the plurality of virtual machines according to their globally unique logical identities. According to one embodiment, the method further comprises storing mappings between the globally unique logical identities of the plurality of virtual machines and physically associated addresses.

According to one embodiment, the method further comprises updating a respective mapping stored by the DBMS between the globally unique logical identity and the physically associated network address in response to migration of a VM to a new location which has a new physically associated network address. According to one embodiment, controlling, by the computer system, communication within the logical network according to the globally unique logical identities includes controlling, by a plurality of hypervisors, communication for the plurality of virtual machines according to the mappings.

According to one embodiment, the computer system includes a plurality of hypervisors associated with at least one or a plurality of cloud providers. According to one embodiment, the method further comprises: assigning, by the plurality of hypervisors, resources from respective cloud providers, including physically associated addresses for the resources, and maintaining, by the plurality of hypervisors, mappings between the globally unique logical identities of the plurality of virtual machines and the physically associated addresses. According to one embodiment, the method further comprises accepting specification of a group of virtual machines to include in a tenant logical network. According to one embodiment, the method further comprises accepting tenant specified definition of the group of virtual machines, wherein tenant specified definition includes identifying information for the group of virtual machines to be included in the tenant logical network.

According to one embodiment, the method further comprises defining an exclusive communication channel over a logical unicast cable for each pair of virtual machines of the plurality of virtual machines. According to one embodiment, the method further comprises activating or de-activating the exclusive communication channel between the pair of virtual machines. According to one embodiment, activating or de-activating the exclusive communication channel between the pair of virtual machines includes activating or de-activating the exclusive communication channel according to tenant defined communication policy. According to one embodiment, the tenant defined communication policy includes criteria for allowing or excluding communication over respective exclusive communication channels.

According to one embodiment, the method further comprises controlling external communication with the plurality of virtual machines at respective vNICs of the plurality of virtual machines. According to one embodiment, a system accessible communication policy can specify communication criteria for external communication. According to one embodiment, managing, by the computer system, communication between a plurality of virtual machines includes managing physical communication pathways between a plurality of physically associated network addresses mapped to respective globally unique logical identities.

According to one aspect, a system for defining a logical network operating in a cloud compute environment is provided. The system comprises at least one processor operatively connected to a memory, a network virtualization infrastructure (NVI) component, executed by the at least one processor, configured to: assign globally unique logical identities to the plurality of virtual machines, map, for each virtual machine, a respective globally unique logical identity to a physically associated network address assigned by a plurality of cloud providers, and manage communication between a plurality of virtual machines by managing physical pathways between physical network addresses which are mapped to the respective globally unique logical identities of the respective plurality of virtual machines.

According to one aspect, a method of providing a virtual network including a plurality of virtual machines to a tenant of a cloud computing environment, the virtual network being secure and tenant-programmable is provided. The method comprises accessing a whitelist, the whitelist including at least one of a respective identity and a respective cryptographic certificate of each node of a plurality of nodes, the plurality of nodes including the plurality of virtual machines, running a proxy entity in the cloud computing environment configured to secure a cryptographic credential of the tenant using the proxy entity, running at least one virtualization infrastructure in the cloud computing environment, running a virtual machine of the plurality of virtual machines on a virtualization infrastructure of the at least one virtualization infrastructure and securing a cryptographic credential of the virtual machine using the virtualization infrastructure, decrypting an input to the virtual machine based on the cryptographic credential of the virtual machine, encrypting an output of the virtual machine to a node of the plurality of nodes, based on a respective cryptographic certificate of the node, in response to accessing the respective cryptographic certificate of the node in the whitelist, and encrypting the output based on a cryptographic certificate of the tenant and routing the output to the node via the proxy entity if the respective cryptographic certificate of the node cannot be accessed in the whitelist.

According to one embodiment, accessing a whitelist includes accessing a whitelist including a respective cryptographic certificate of each virtual machine of the plurality of virtual machines. According to one embodiment, accessing a whitelist includes accessing a whitelist including a respective identity of each of one or more nodes of the plurality of nodes, each of the one or more nodes not having a respective cryptographic certificate. According to one embodiment, routing the output to the node via the proxy entity further includes routing the output to the node after decrypting the output by the proxy entity based on the cryptographic credential of the tenant. According to one embodiment, the respective cryptographic certificate of each node is a respective public key certificate of each node, the cryptographic credential of the virtual machine is a private key of the virtual machine, the cryptographic credential of the tenant is a private key of the tenant and the cryptographic certificate of the tenant is a public key certificate of the tenant.

Still other aspects, embodiments and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment. References to “an embodiment,” “an example,” “some embodiments,” “some examples,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a block diagram of an example network topology;

FIG. 2 is a block diagram of an example network topology;

FIG. 3 is a block diagram of an example network topology;

FIG. 4 is a block diagram of an example NVI system, according to one embodiment;

FIG. 5 is a block diagram of an example NVI system, according to one embodiment;

FIG. 6 is a block diagram of an example distributed firewall, according to one embodiment;

FIG. 7 is an example process for defining and/or maintaining a tenant network, according to one embodiment;

FIG. 8 is an example certification employed in various embodiments;

FIG. 9 is an example process for execution of a tenant defined communication policy, according to one embodiment;

FIG. 10 is an example process for execution of a tenant defined communication policy, according to one embodiment;

FIG. 11 is an example user interface, according to one embodiment;

FIG. 12 is a block diagram of an example tenant programmable trusted network, according to one embodiment;

FIG. 13 is a block diagram of a general purpose computer system on which various aspects and embodiments may be practiced; and

FIG. 14 is a block diagram of an example logical network, according to one embodiment.

### DETAILED DESCRIPTION

At least some embodiments disclosed herein include apparatus and processes for creating and managing a globally distributed and intelligent NVI. The NVI is configured to provide a logical network implemented on cloud resources. According to some embodiments, the logical network enables communication between VMs using logically defined unicast channels defined on logical addresses within the logical network. Each logical address can be a globally unique identifier that is associated by the NVI with addresses assigned to the cloud resources (e.g., physical addresses or physically associated addresses) by respective cloud datacenters or providers. In some embodiments, the logical addresses remain unchanged even as physical network resources supporting the logical network change, for example, in response to migration of a VM of the logical network to a new location or a new cloud provider.

In some embodiments, the NVI includes a database or other data storage element that records a logical address for each virtual machine of the logical network. The database can also include a mapping between each logical address and a physically associated address for the resource(s) executing the VM. For example, a logical network ID (e.g., UUID or IPv6 address) is assigned to a vNIC of a VM and mapped to a physical network address and/or context tag assigned by the cloud provider to the resources executing the VM. In further embodiments, the NVI can be associated with a database management system (DBMS) that stores and manages the associations between logical identities/addresses of VMs and underlying physical addresses of the resources. According to some embodiments, the logical identities/addresses of the VMs never change even as the location of the VM changes. For example, the NVI is configured to update the mappings to permanent logical addresses of the VMs with physically associated addresses as resources assigned to the logical network change.

Further embodiments include apparatus and processes for provisioning and isolating network resources in cloud environments. According to some embodiments, the network resources can be rented from one or more providers hosting respective cloud datacenters. The isolated network can be configured to provide various quality of service (“QoS”) guaranties and or levels of service. In some implementations, QoS features can be performed according to software developed network principals. According to one embodiment, the isolated network can be purely logical, relying on no information of the physical locations of the underlying hardware network devices. In some embodiments, implementation of purely logical network isolation can enable trans-datacenter implementations and facilitate distributed firewall policies.

According to one embodiment, the logical network is configured to pool underlying hardware network devices (e.g., those abstracted by the logical network topology) for network control into a network resource pool. Some properties provided by the logical network include, for example: a tenant only sees and on-demand rents resources for its business logic; the tenant should never care where the underlying hardware resource pool is located; and/or how the underlying hardware operates.

According to some embodiments, the system provides a globally distributed and intelligent network virtualization infrastructure (“NVI”). The hardware basis of the NVI can consist of globally distributed and connected physical computer servers which can communicate one another using any conventional computer networking technology. The software basis of the NVI consists of hypervisors (i.e., virtual machine managers) and database management systems

(DBMS) which can execute on the hardware basis of the NVI. According to some embodiments, the NVI can include the following properties: first, any two hypervisors of a cloud provider or different cloud providers in the NVI can be configured to communicate one another on their respective physical locations. If necessary, the system can use dedicated cable connection technologies or well-known virtual private network (VPN) technology to connect any two or more hypervisors to form a globally connected NVI. Second, the system and/or virtualization infrastructure knows of any communication event which is initiated by a virtual machine (VM) more directly and earlier than a switch does when the latter sees a network packet.

It is realized that, the latter event (detection at a switch) is only observed as a result of the NVI sending the packet from a vNIC of the VM to the switch. The prior event (e.g., detection at initiation) is a property of the NVI managing the VM's operation, for example at a vNIC of the VM, which can include identifying communication by the NVI at initiation of a communication event (e.g., prior to transmission, at receipt, etc.). Thus, according to some embodiments, the NVI can control and manage communications for globally distributed VMs via its intelligently connected network of globally distributed hypervisors and DBMS.

According to some aspects, these properties of the NVI enable the NVI to construct a purely logical network for globally distributed VMs. In some embodiments, the control functions for the logical network of globally distributed VMs, which defines the communications semantics of logical network (i.e., governs how VMs in the logical network communicate), is implemented in, and executed by, software components which work with hypervisors and DBMS of the NVI to cause some function to take effect at vNICs of VMs; and the network dataflow for logical network of globally distributed VMs passes through the physical networking components which underlie the logical network and connect the globally distributed hypervisors of the NVI. It is realized that the separation of network control function in software (e.g., operating at vNICs of VMs), from network dataflow through the physical networking components allows definition of the logical network without physical network attributes. In some implementations, the logical network definition can be completely de-coupled from the underlying physical network.

According to one aspect, the separation of network control function on vNICs of VMs, from network dataflow through underlying physical network of the NVI result in communications semantics of logical network of globally distributed VMs that can be completely software defined, or in other words, results in a logical network of globally distributed VMs that according to some embodiments can be a software defined network (SDN): where communications semantics can be provisioned automatically, fast and dynamically changing, with trans-datacenter distribution, and with a practically unlimited size and scalability for the logical network.

According to some embodiments, using software network control functions that take effect directly on vNICs enables construction of a logical network of VMs of global distribution and unlimited size and scalability. It is realized that network control methods/functions whether in software or hardware in conventional systems (including, e.g., OpenFlow) take effect in switches, routers and/or other network devices. Thus, it is further realized that, e.g., construction of a large scale of logical network in conventional approaches is at best in step-by-step protocol patching (i.e., combining) of switches, routers and/or other network devices, which is impractical for a globally distributed, trans-datacenter, or unlimited scalability network.

Examples of control function to take effect directly on vNICs of VMs of some embodiments include any one or more of: (i) plug/unplug logically defined unicast cables to implement network isolation policy, (ii) transform IPv6-IPv4 versions of packets, (iii) encrypt/decrypt or IPsec based protection on packets, (iv) monitor and/or divert traffics, (v) detect intrusion and/or DDoS attacks, (vi) account fees for traffic volume usage, among other options.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

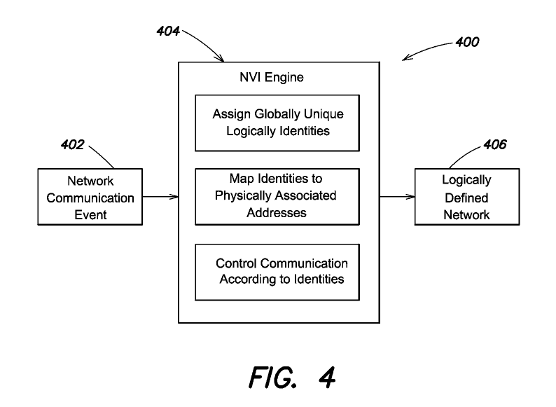

Shown in FIG. 4 is an example embodiment of a network virtualization infrastructure (NVI) system 400. According to one embodiment, the system 400 can be implemented on and/or in conjunction with resources allocated by cloud resource providers. In further embodiments, system 400 can be hosted, at least in part, external to virtual machines and/or cloud resources rented from cloud service providers. In one example, the system 400 can also serve as a front end for accessing pricing and rental information for cloud compute resources.

According to one embodiment, a tenant can access system 400 to allocate cloud resources from a variety of providers. Once the tenant has acquired specific resources, for example, in the form of virtual machines hosted at one or more cloud service providers, the tenant can identify those resources to define their network via the NVI system 400.

In another example, the logic and/or functions executed by system 400 can be executed on one or more NVI components (e.g., hypervisors (virtual machine managers)) within respective cloud service providers. In other embodiments, one or more NVI components can include proxy entities configured to operate in conjunction with hypervisors at respective cloud providers. The proxy entities can be created as specialized virtual machines that facilitate the creation, definition and control function of a logical network (e.g., a tenant isolated network).

Creation of the logical network can include, for example, assignment of globally unique logical addresses to VMs and mapping of the globally unique logical addresses to physically associated addresses of the resources executing the VMs. In one embodiment, the proxy entities can be configured to define logical communication channels (e.g., logically defined virtual unicast cables) between pairs of VMs based on the globally unique logical addresses. Communication between VMs can occur over the logical communication channels without regard to physically associated addressing which are mapped to the logical addresses/identities of the VMs. In some examples, the proxy entities can be configured to perform translations of hardware addressed communication into purely logical addressing and vice versa. In one example, a proxy entity operates in conjunction with a respective hypervisor at a respective cloud provider to capture VM communication events, route VM communication between a vNIC of the VM and a software switch or bridge in the underlying hypervisor upon which the proxy entity is serving the VM. In some embodiments, a proxy entity is a specialized virtual machine at respective cloud providers or respective hypervisors configured for back end servicing. In some examples, a proxy entity manages internal or external communication according to communication policy defined on logical addresses of the tenants' isolated network (e.g., according to network edge policy).

In further examples, the NVI system 400 can also include various combinations of rented cloud resources, hypervisors, and/or systems for allocating cloud resources through various providers. Once a set of cloud resources have been assigned, the NVI system 400 can be configured to map globally unique identities of respective virtual machines to the physically associated addresses of the respective resources. According to some embodiments, the NVI system 400 can include an NVI engine 404 configured to assign globally unique identities of a set of virtual machines to resources allocated by hypervisors to a specific tenant. The set of virtual machines can then be configured to communicate with each other using the globally unique identities. In one embodiment, the NVI system and/or NVI engine is configured provide network control functions over logically defined unicast channels between virtual machines within a tenant network. For example, the NVI system 400 can provide for network control at each VM in the logical network. According to one embodiment, the NVI system 400 can be configured to provide network control at a vNIC of each VM, allowing direct control of network communication of the VMs in the logical network. The NVI system 400 can be configured to define point-to-point connections, including for example, virtual cable connections between vNICs of the virtual machines of the logical network using their globally unique addresses. Communication within the network can proceed over the virtual cable connections defined between a source VM and a destination VM.

According to one embodiment, the NVI system 400 and/or NVI engine 404 can be configured to open and close communication channels between a source and a destination (including, for example, internal and external network addresses). The NVI system 400 and/or NVI engine 404 can be configured to establish virtual cables providing direct connections between virtual machines that can be connected and disconnected according to a communication policy defined on the system. In some examples, each tenant can define a communication policy according to their needs. The communication policy can be defined on a connection by connection basis, both internally to the tenant network and by identifying external communication connections. In one example, the tenant can specify for an originating VM in the logical network what destination VMs the originating VM is permitted to communicate with based on globally unique logical identities assigned. Further, the tenant can define communication policy according to source and destination logical identities.

According to one implementation, the NVI system 400 and/or NVI engine 404 can manage each VM of the logical network according to an infinite number of virtual cables defined at vNICs for the VMs. For example, virtual cables can be defined between pairs of VMs and their vNICs for every VM in the logical network. The tenant can define communication policy for each cable, allowing or denying traffic according to programmatic if then else logic.

By allowing tenants to establish communication policies according to the global unique identities/addresses, the NVI system and/or engine are configured to provide distributed firewall services. According to various implementations, distribution of connection control can eliminate the chokepoint limitations of conventional architectures, and in further embodiments, permit dynamic re-architecting of a tenant network topology (e.g., adding, eliminating, and/or moving cloud resources that underlie the logical network).

As discussed, the NVI system 400 and/or engine 404 can be configured to allocate resources at various cloud compute providers. In some embodiments, system and/or engine can be executed by one or more hypervisors at the respective cloud providers. In other embodiments, the system and/or engine can be configured to request respective hypervisors create virtual machines and provide identifying information for the created virtual machines (e.g., to store mappings between logical addresses and physically associated address of the resources). In further embodiments, the functions of system 400 and/or engine 404 can executed by a respective hypervisor within a cloud provider system. In some implementations, the functions of system 400 and/or engine 404 can executed by and/or include a specialized virtual machine or proxy entity configured to interact with a respective hypervisor. The proxy entity can be configured to request resources and respective cloud provider identifying information (including physically associated addresses for resources assigned by hypervisors).

In one example, the system and/or engine can be configured to request, capture, and/or assign temporary addresses to any allocated resources. The temporary addresses are “physically associated” addresses assigned to resources by respective cloud providers. For example, the temporary addresses are used in conventional networking technologies to provide communication between resources and to other, for example, internet addresses. Typically in conventional communications, the physically associated addresses are included in network packet metadata, either as a MAC address or an IP address or a context tag.

Rather than permit VMs to communicate via physically associated addresses directly, the NVI system 400 de-couples any physical association in its network topology by defining logical addresses for each VM in the logical network. In some examples, communication can occurs over virtual cables that connect pairs of virtual machines using their respective logical addresses. For example, the system and/or engine 404 can be configured to manage creation/allocation of virtual machines and also manage communication between the VMs of the logical network at respective vNICs. The system 400 and/or engine 404 can also be configured to identify communication events at the vNICs of the virtual machines when the virtual machines initiate or respond to a communication event. Such direct control can provide advantages over conventional approaches.

As discussed, the system and/or engine can include proxy entities at respective cloud providers. The proxy entities can be configured to operate in conjunction with respective hypervisors to obtain hypervisor assigned addresses, identify communication events initiated by respective virtual machines, map physically associated addresses assigned by the hypervisors to logical addresses of the VMs, and define virtual cables between network members, etc. In some embodiments, a proxy entity can be created at each cloud provider involved in a tenant network, such that the proxy entity manages the virtualization/logical isolation of the tenant's network. For example, each proxy entity can be a back-end servicing VM configured to provide network control functions on the vNICs of front-end business VMs (between vNICs of business VM and hypervisor switch or hypervisor bridge), to avoid programming in the hypervisor directly.

According to one embodiment, the system 400 and/or engine 404 can also be configured to implement communication policies within the tenant network. For example, when a virtual machine begins a communication session with another virtual machine, the NVI system 400 and/or NVI engine 404 can identify the communication event and test the communication against tenant defined policy. The NVI system 400 and/or NVI engine 404 component can be configured to reference physically associated addresses for VMs in the communication and lookup their associated globally unique addresses and/or connection certificates (e.g., stored in a DBMS). In some settings, encryption certificates can be employed to protect/validate network mappings. In one example, a PKI certificate can be used to encode a VM's identity—Cert(UUID/IPv6) with a digital signature for its global identity (e.g., UUID/IPv6) and physically associated address (e.g., IP)—Sign(UUID/IPv6, IP). The correctness of the mapping (UUID/IPv6, IP) can then be cryptographically verified by any entity using Cert(UUID/IPv6) and Sign(UUID/IPv6, IP). The NVI system 400 and/or NVI engine 404 can verify each communication with a certificate lookup and handle each communication event according to a distributed communication policy defined on the logical connections.

According to some implementations, the NVI system 400 provides a logically defined network 406 de-coupled from any underlying physical resources. Responsive to any network communication event 402 (including for example, VM to VM, VM to external, and/or external to VM communication), the NVI system is configured to abstract the communication event into the logical architecture of the network 406. In one embodiment, the NVI system “plugs” or “unplugs” a virtual cable at respective vNICs of VMs to carry the communication between a source and a destination. The NVI system can control internal network and external network communication according to the logical addresses by “plugging” and/or “unplugging” virtual cables between the logical addresses at respective vNICs of VMs. As the logical address for any resource within a tenant network are globally unique, new resources can be readily added to the tenant network, and can be readily incorporated into communication policies defined for the tenant network. Further, as new resources are assigned and mapped to logical addresses, the physical location of a newly added resource is irrelevant. As the physical location is irrelevant, new resources can be provisioned from any cloud provider.

In some embodiments, the NVI system 400 and/or NVI engine 404 can be configured to accept tenant identification of virtual resources to create a tenant network. For example, the tenant can specify VMs to include in their network, and as reaction to the tenant request, the NVI can provide physically associated addressing information to map to the logical addresses of the tenant requested VMs allocated by respective cloud providers for the resources executing the VMs to define the tenant network.

The system can be configured assign new globally unique identifiers to each resource. The connection component 408 can also be configured to accept tenant defined communication policies for the new resources. In some implementations, the tenant can define their network using a whitelist of included resources. In one example, the tenant can access a user interface display provided by system 400 to input identifying information for the tenant resources. In further embodiments, the tenant can add, remove, and/or re-architect their network as desired. For example, the tenant can access the system 400 to dynamically add resources to their whitelist, remove resources, and/or create communication policies.

In some embodiments, the NVI system 400 can also provide for encryption and decryption services to enable additional security within the tenant's network and/or communications. In some embodiments, the NVI system and/or NVI engine 404, can be configured to provide for encryption.

According to another aspect, the NVI system 400 can also be configured to provision additional resources responsive to tenant requests. The NVI system 400 can dynamically respond to requests for additional resources by creating global addresses for any new resources. In some implementations, a tenant can define a list of resources to include in the tenant's network using system 400. For example, upon receipt the tenant's resource request, the NVI can create resources for the tenant in the form of virtual machines and specify identity information for the virtual machines to execute as allocated by whatever cloud provider they used. The system 400 can be configured to assign globally unique identifiers to each virtual machine identified by the NVI for the tenant and store associations between globally unique identifiers and resource addresses for use in communicating over the resulting NVI network. In further embodiments, the system can create encryption certificates for a tenant for each VM in the NVI logical network, which is rented by the tenant. In some examples, the NVI can specify encryption certificates for a tenant as part of providing identity information for virtual machines to use in the tenant's network. The NVI system can then provide for encryption and decryption services as discussed in greater detail herein.

### NVI—Example Advantages Over Existing Approaches

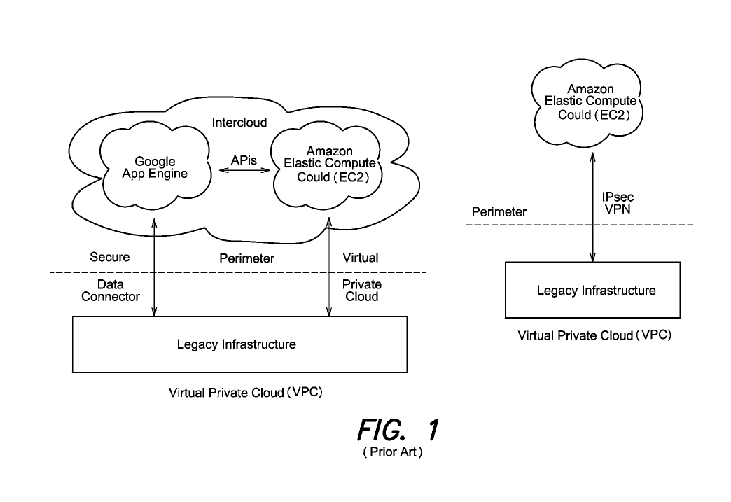

Various advantages and features of some embodiments and aspects can be better appreciated with an understanding of conventional approaches, for example, as illustrated in FIGS. 1-3. Some conventional approaches are described as well as the limitations discovered for such systems. Various embodiments are discussed with respect to overcoming the discovered limitations of some conventional approaches. With the rise of cloud computing, the conventional approach of IT asset ownership is transitioning to IT as a service utilization. The conventional lifestyle of owning hardware machines standing on floors, and desks is evolving into a new lifestyle of virtual machines (VMs) standing on powerfully intelligent and globally distributed software of virtualization infrastructure (VI) which consists of globally distributed hypervisors under centralized management of also globally distributed database management systems.

Before virtualization, every physical IT business processing box (below, IT box) included a physical network interface card (NIC) which can be plugged to establish a connection between two ends (a wireless NIC has the same property of “being plugged as a cable”), and the other end of the cable is a network control device. Any two IT boxes may or may not communicate with one another provided they are under the control of some network control devices in-between them. The means of controlling communications between IT boxes occurs by the control devices inspecting and processing some metadata—addresses and possibly more refined contexts called tags—in the head part of network packets: permitting some packets to pass through, or dropping others, according to the properties of the metadata in the packets against some pre-specified communications policy. This control through physically associated addressing (e.g., MAC addresses, IP addresses and or context tags) has a number of drawbacks.

Although physical resources are currently becoming virtualized, various virtual implementation still use conventional network packet metadata processing (i.e., physically associated addressing) to control communications for virtual machines. For example, in

Openstack operation includes sending network packets of a VM to a centralized network device (of course, in Openstack the network device may be a software module in a hypervisor, called hypervisor switch or hypervisor bridge) via a network cable (which may also be software implemented in a hypervisor), for passing through or dropping packets at centralized control points.

This conventional network control technology of processing packets metadata at centralized control points has various limitations in spite of virtualization. The centralized packets processing method which processes network control in the meta-data or head part, and forwards dataflow in the main-body part, of a network packet at a centralized point (called chokepoint) cannot make efficient use of the distributed computing model of the VI; centralized packets processing points can form a performance bottleneck at large scale. The packet metadata inspection method examines a fraction of metadata (an address or a context tag) in the head of a whole network packet, and then may drop the whole packet (resulting in wasted network traffic). Additionally, the metadata (addresses and tags) used in the head of a network packet are still physically associated (i.e., related to) the physical location of hardware of respective virtualized resources. Physical associations are not an issue for on on-site and peak-volume provisioned physical resources (IT as an asset model), where changes in topology are infrequent. Generally, for IT as an asset, network scalability, dynamic changes of network topology and distribution, and the like network quality of services (QoS) do not pose the same issues as is found with off-site and on-demand utilization of services such as virtualized infrastructure of cloud computing.

With virtualization technology enabled cloud computing, the user or tenant may require an on-demand elastic way to rent IT resources, and may also rent from geographically different and scattered locations of distributed cloud datacenters (e.g., to increase availability and/or reliability). Cloud providers may also require the ability to move assigned resources to maximize utilization and/or minimize maintenance. These requirements in cloud computing translate to needs for resource provisioning with the following properties: automatic, fast and dynamic changing, trans-datacenter scalable, and for IT resource being network per se, a tenant's network should support a tenant-definable arbitrary topology, which can also have a trans-datacenter distribution.

It is realized that the network inside a cloud datacenter upon which various QoS can be performed in SDN should be a purely logical one. By implementing a purely logical network topology over physical network resources, the properties provided by various embodiments can include: logical addressing containing no information on the physical locations of the underlying physical network devices; and enabling pooling of hardware devices for network control into a network resource pool. Various implementations can also take advantage of conventional approaches to allow hypervisors of respective cloud providers to connect with each other (e.g., VPN connections) underneath the logical topology. Further, various embodiments can leverage management of VMs by the hypervisors and/or proxy entities to capture and process communication events. Such control allows communication events to be captured more directly and earlier than, for example, switch based control (which must first receive the communication prior to action). Thus, various embodiments can control and manage communications for globally distributed VMs without need of inspecting and processing any metadata in network packets.

Conventional firewall implementations focus on a “chokepoint” model: an organization first wires its owned, physically close-by IT boxes to some hardware network devices to form the organization's internal local area network (LAN); the organization then designates a “chokepoint” at a unique point where the LAN and wide area network (WAN) meet, and deploys the organization's internal and external communications policy only at that point to form the organization's network edge. Conventional firewall technologies can use network packet metadata such as IP/MAC addresses to define LAN and configure firewall. Due to the seldom changing nature of network configurations, it suffices for the organization to hire specialized network personnel to configure the network and firewall, and suffices for them to use command-line-interface (CLI) configuration methods.

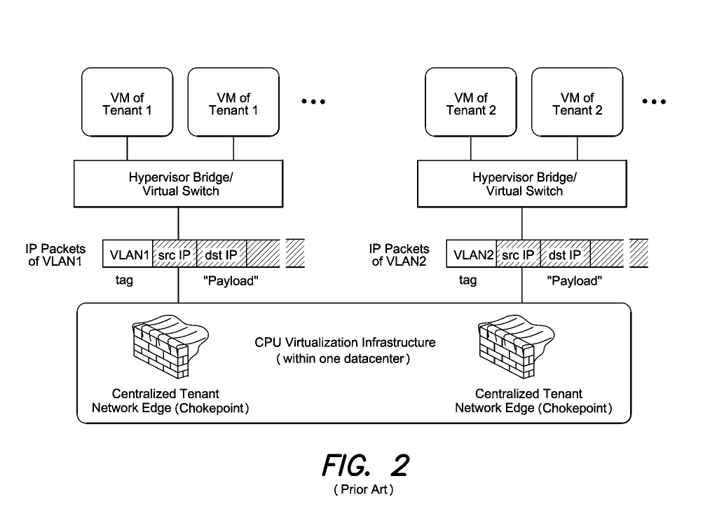

In cloud computing, an organization's private network and firewall are often deployed in the server virtualization multi-tenancy datacenters. A firewall in this setting needs be virtualized and isolated from the remainder of the datacenters. In the some known approaches (e.g., Openstack) firewalls are based on the VLAN technology. To deploy the VLAN technology in the VI, the physical hardware switches are “virtualized” into software counterparts in hypervisors (see FIG. 2), which are either called “hypervisor learning bridges”, or “virtual switches” (“hypervisor switch” is a more meaningful name). These are software components in hypervisors connecting vNICs of VMs to the hardware NIC on the server. They are referred to below interchangeably as a hypervisor switch.

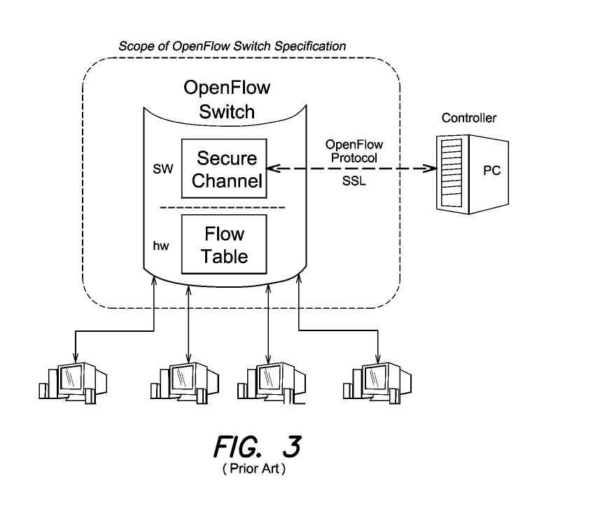

Like a hardware switch, a hypervisor switch involves in a LAN construction also by learning and processing network packet metadata such as addresses. Also like the hardware counterpart, a hypervisor switch can refine a LAN by adding more contexts to the packet metadata. The additional contexts which can be added to the packet metadata part by a switch (virtual or real) are called tags. The hypervisor switch can add different tags to the network packets of IT boxes which are rented by different tenants (see FIG. 2). These different tenants' tags divide a LAN into isolated virtual LANs, isolating tenants' networks in a multi-tenancy datacenter. In some examples, VLAN technology is for network cable virtualization: packets sharing some part of a network cable are labeled differently and thereby can be sent to different destinations, just like passengers in an airport sharing some common corridors before boarding at different gates, according to the labels (tags) on their boarding passes. Another approach includes the OpenFlow protocol technology in Openstack shown in FIG. 3.

The OpenFlow protocol technology takes a so-called “many-to-1” approach to consolidating network switches: a plural number of hypervisor switches and hardware switches are organized into one centrally “virtualized” logical switch (See FIG. 3). Such a centralized logical switch permits centralized network configurations and data-plane manipulation, however, the OpenFlow protocol model for network control is still based in the conventional chokepoint working principle.

In FIG. 3, the lines connecting the terminals to the “many-to-1-style” OpenFlow consolidated logical switch module are all network cables (including software implemented cables). A software coded network cable is more often referred to as a “hypervisor bridge” connecting the vNIC of a VM and the hardware NIC on the server. It is realized that the “many-to-1” consolidated OpenFlow switch is a big logical switch consisting of many specially designed hardware implemented small switches. The dependence on installing completely new and large scale of hardware switch infrastructure forms a very big hurdle for the OpenFlow technology to achieve quick commercial deployment.

Another limitation of the OpenFlow technology is that the “many-to-1” consolidation of switches can only take place within one datacenter. It is realized this architecture does not support construction of a trans-datacenter scaled LAN, and therefore is not suitable for building a cloud network. As discussed, in-datacenter location specific attributes do not work well with programming network QoS, and in particular do not work well for programming QoS with trans-datacenter scalability.

Accordingly, provided in various implementations is a new network virtualization infrastructure (NVI) leveraging direct communication control over VMs to establish a fully logical network architecture. Direct control over each VM, for example through a hypervisor and/or proxy entity, is completely distributed and at the location where the VM with vNICs currently is executing. An advantage of the direct network control function on a vNIC is that the communication control can avoid complex processing network packets metadata which are tight coupled with physical locations of the network control devices, instead, using purely logical addresses of vNICs. In some examples, the resultant logical network eliminates any location specific attributes of the underlying physical network. SDN work over the NVI can be implemented simply and as straightforward high-level language programming.

According to some embodiments, if VMs' communications are intermediated by the NVI, then each VM can be viewed by the NVI to have an infinite number of vNIC cards, where each can be plugged as a logically defined unicast cable for exclusive use with a single given communications partner. As a hypervisor in the NVI is responsible for passing network packets from/to the vNIC of a VM right at the spot of the VM, the NVI can be configured for direct quality of control, either by controlling communication directly with the hypervisor or by using a proxy entity coupled with the hypervisor. By contrast, a switch, even a software coded hypervisor switch, can only control VM's communications via packets metadata received from a multicast network cable. It is appreciated that the difference between a VM being plugged to multiple unicast cables under the NVI's direct control, and the VM being plugged into one multicast cable under the switch's indirect and packet metadata control, is non-trivial. A logical network which is constructed by multiple, real-time plugged/unplugged, unicast cables needn't manage any packet metadata with physical network attributes anymore. Thus, by enabling direct control of VM communication through the NVI, the resultant logical network can be completely de-coupled from the underlying physical network.

### Example NVI Implementations

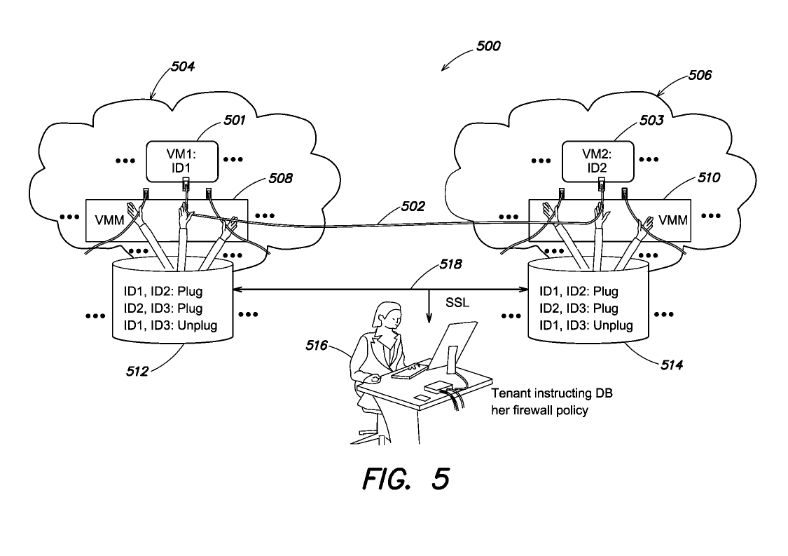

FIG. 5 illustrates an example implementation of network virtualization infrastructure (NVI) technology according to one embodiment. The NVI system 500 and corresponding virtualization infrastructure (VI) which can be globally distributed over a physical network can be configured to plug/unplug a logically defined unicast network cable 502 for any given two globally distributed VMs (e.g., 501 and 503 hosted, for example, at different cloud datacenters 504 and 506). As discussed, the respective VMs (e.g. 501 and 503) are managed throughout their lifecycle by respective virtual machine managers (VMMs) 508 and 510.

From the moment of a VM's (e.g., 501 and 503) inception and operation, the VM obtains a temporary IP address assigned by a respective hypervisor (e.g., VMM 508 and 510). The temporary IP address can be stored and maintained in respective databases in the NVI (e.g., 512 and 514). Through the whole lifecycle of assigned VMs, the temporary IP addresses can change, however, as the addresses change or resources are added and/or removed any temporary IP addresses are maintained in respective databases. The databases (e.g., 512 and 514) are also configured to store globally identifiable identities in association with each virtual machines' assigned address.

By maintaining a mapping between unchanging unique IDs and potentially changing but maintained temporary IP addresses, then the NVI can be configured to plug/unplug logically defined unicast cable between any two given network entities using unchanging unique IDs (so long as one of communicating entities is a VM within the NVI). According some embodiments, the NVI constructs the logical network by defining unicast cables to plug/unplug avoiding processing of packet metadata. In some embodiments, centrally positioned switches (software or hardware) can still be employed for connecting the underlying physical network, but conventional problems associated with dropping multicast traffic based on packet metadata do not arise, as communications occur over the virtual unicast cables, or communication policy prevents communication directly at the VM. The network control for VMs can therefore be globally distributed given that the VM ID is globally identifiable, and operates without location specific packet metadata.

According to some embodiments, respective hypervisors and associated DBMS in the NVI have fixed locations, i.e., they typically do not move and/or change their physical locations. Thus, in some embodiments, globally distributed hypervisors and DBMS can use the conventional network technologies to establish connections underlying the logical network. Such conventional network technologies for constructing the underlying architecture used by the NVI can be hardware based, for which command-line-interface (CLI) based configuration methods are sufficient and very suitable. For example, a CLI-based virtual private network (VPN) configuration technology can be used for connecting globally distributed hypervisors and DBMS.

Various methodologies exist for assigning globally unique identifiers. In some embodiments, the known Universally Unique Identity, (“UUID”) methodology is executed to identify each VM. For example, each VM can be assigned a UUID upon creation of its image file. In another example, IPv6 addresses can be assigned to provide globally unique addresses. Once assigned, the relationship between the UUID and the physically associated address for any virtual machine can be stored for later access (e.g., in response to a communication event). In other embodiments, other globally identifiable unique and unchanging identifiers can be used in place of UUID.

In some embodiments, the UUID of a VM will not change throughout the VM's complete lifecycle. According to one embodiment, each virtual cable between two VMs is then defined on the respective global identifiers. In some implementations, the resulting logical network constructed by plugged unicast cables over the NVI is also completely defined by the UUIDs of the plugged VMs. In further embodiments, the NVI is configured to plug/unplug the unicast cables in real-time according to a given set of network control policy in the DBMS. For example, a tenant 516 can securely access (e.g., via SSL 518) the control hub of the logical network to define a firewall policy for each communication cable in the logical network.

According to some aspects, any logic network defined on the never changing UUIDs of the VMs, can have network QoS (including, for example, scalability) addressed by programming purely in software. According to other aspects, such logic networks are easy to change, both in topology or in scale, by SDN methods, even across datacenters.

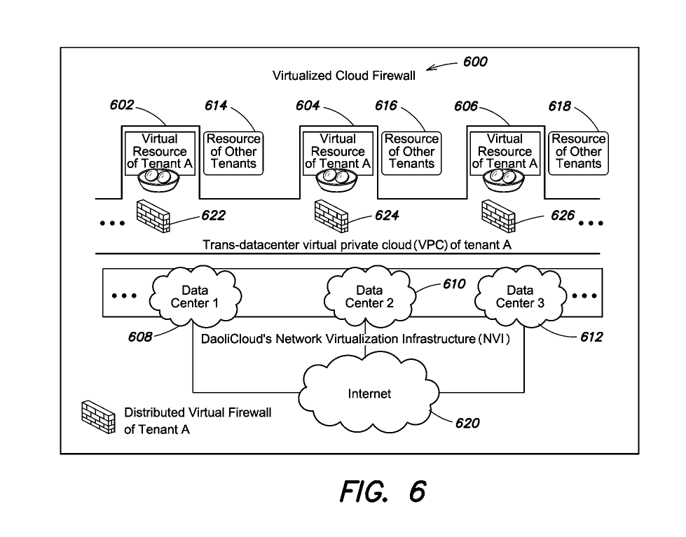

Once a tenant network is established, the tenant can implement a desired firewall using, for example, SDN programming. According to some embodiments, the tenant can construct a firewall with a trans-datacenter distribution. Shown in FIG. 6 is an example of a distributed firewall 600. Virtual resources of the tenant A 602, 604, and 606 span a number of data centers (e.g., 608, 610, and 612) connected over a communication network (e.g., the Internet 620). Each datacenter provides virtual resources to other tenants (e.g., at 614, 616, and 618), which are isolated from the tenant A′s network. Based on management of communication, both internal and external through plug/unplug unicast cables, the tenant A is able to define a communication policy that enables communication on a cable by cable basis. As communication events occur, the communication policy is checked to insure that each communication event is permitted. For example, a cable can be plugged in real-time in response to VM 602 attempting to communicate with VM 604. For example, the communication policy defined by the tenant A can permit all communication between VM 602 and VM 604. Thus, a communication initiated at 602 with destination 604 passes the firewall at 622. Upon receipt, the communication policy can be checked again to insure that a given communication is permitted, in essence passing the firewall at 624. VM 606 can likewise be protected from both internal VM communication and externally involved communication, shown for illustrative purposes at 626.

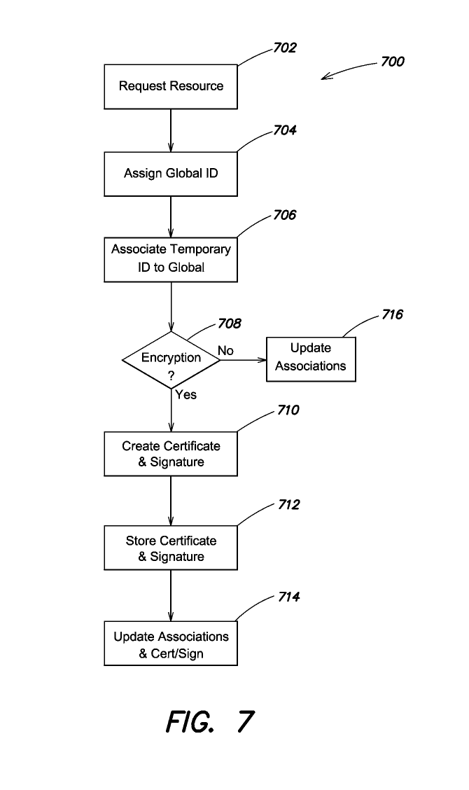

FIG. 7 illustrates an example process 700 for defining and/or maintaining a tenant network. The process 700 can be executed by an NVI system to enable a tenant to acquire resources and define their own network across rented cloud resources. The process 700 begins at 702 with a tenant requesting resources. In some embodiments, various processes or entities can also request resources to begin process 700 at 702. In response to a request to allocate/rent resources, a hypervisor or VMM having available resources can be selected. In some embodiments, hypervisors can be selected based on pricing criteria, availability, etc. At 704, the hypervisor creates a VM assigned to the requestor with a globally uniquely identifiable id (e.g., a UUID/IPv6 address). The global ID can be added to a database for the tenant network. Each global id is associated with a temporary physical address (e.g., an IP address available from the NVI) assigned to the VM by its hypervisor. The global id and the temporary physical address for the VM are associated and stored at 706. In one example, a hypervisor creates in a tenant's entry in the NVI DB a new entry: UUID/IPv6 for the newly created VM with the current network address of the VM (IP below denotes the current physical network address which is mapped to the UUID/IPv6 of the VM over the hypervisor).

According to various embodiments, the tenant and/or resource requestor can also implement cryptographic services. For example, the tenant may wish to provide integrity protection on VM IDs to provide additional protection. If crypto protection is enabled 708 YES, then optional cryptographic functions include applying public-key cryptography to create a PKI certificate Cert(UUID/IPv6) and a digital signature Sign(UUID/IPv6, IP) for each tenant VM such that the correctness of the mapping (UUID/IPv6, IP) can be cryptographically verified by any entity using Cert(UUID/IPv6) and Sign(UUID/IPv6, IP). In one embodiment, a cryptographic certificate for the VM ID and signature for the mapping between the ID and the VM's current physical location in IP address are created at 710 and stored, for example, in the tenant database at 712. Process 700 can continue at 714. Responsive to re-allocation of VM resource (including, for example, movement of VM resources) a respective hypervisor (for example a destination hypervisor (“DH”) takes over the tenant's entry in the NVI DB maintenance job for the moved VM. The moved VM is assigned a new address consistent with the destination hypervisors network. Once the new address is assigned, a new mapping between the VM's global ID and the new hypervisor address is created (let IP' denote the new network address for the VM over DH). At 714, the DH updates encryption certifications Sign(UUID/IPv6, IP') in the UUID/IPv6 entry to replace the prior and now invalid certificate Sign(UUID/IPv6, IP).

If crypto protection of VM IDs is not enabled 708 NO, movement of VMs in the tenant network can be managed at 716, by the DH associating a new physical address with the global ID assigned to the VM. The new association is stored in a tenant's entry in the NVI DB, defining the tenant network. In some embodiments, a tenant may already have allocated resources through cloud datacenter providers. In some examples, the tenant may access an NVI system to know identifying information for already allocated resources. The NVI can then assign global ID of VMs to the physically associated addresses of resources. As discussed above, the identities and mappings can be cryptographically protected to provide additional security.

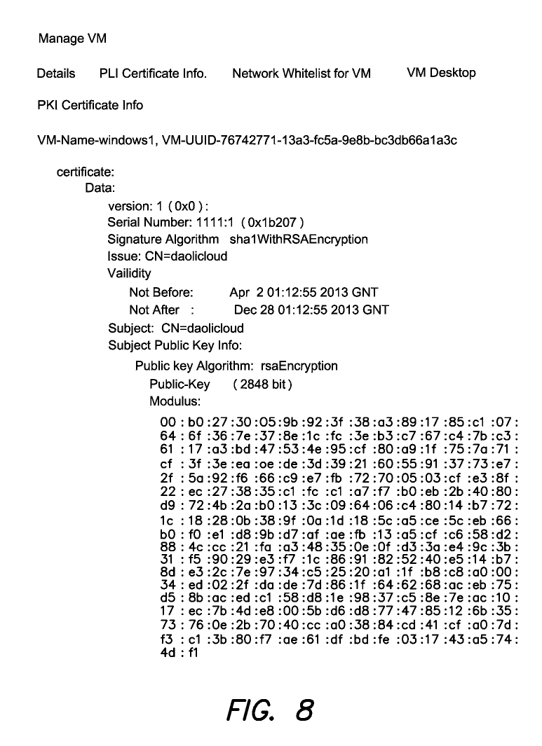

Shown in FIG. 8 is an example PKI certificate than can be employed in various embodiments. In some implementations, known security methodologies can be implemented to protect the cryptographic credential of a VM (the private key used for signing Sign(UUID/IPv6, IP) and to migrate credentials between hypervisors within a tenant network (e.g., at 714 of process 700). In one example, known “Trusted Computing Group” (TCG) technology is implemented to protect and manage cryptographic credentials. For example, a TPM module can be configured to protect and manage credentials within the NVI system and/or tenant network. In some implementations, known protection methodologies can include hardware based implementation, and hence can prevent very strong attacks to the NVI, and for example, can protect against attacks launched by a datacenter system administrator. According to various embodiments, TCG technology also supports credential migration (e.g., at 714).

Once a tenant logical network is defined (for example, by execution of process 700) the tenant can establish a communication policy within their network. For example, the tenant can define algorithms for plugging/unplugging unicast cables defined between VMs in the tenant networks, and unicast cables connecting external address to internal VMs for the tenant network. According to some embodiments, as the algorithms are executed for communications, they can be referred to as communication protocols. In some embodiments, the tenant can define communication protocols for VMs as senders and as receivers.

### Example Distributed Cloud Tenant Firewall

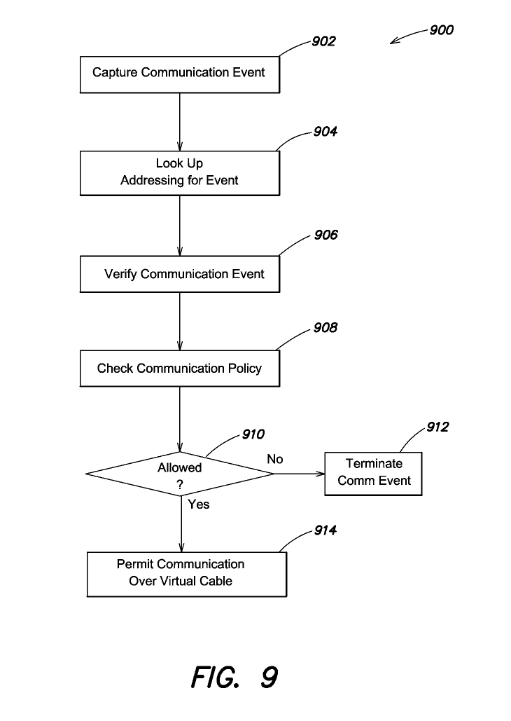

Shown in FIG. 9 is an example process flow 900 for execution of a tenant defined communication policy. The process 900 illustrates an example flow for a sender defined protocol (i.e., initiated by a VM in the tenant network). At execution of 900 VM1 associated with a physically associated address (“SIP”) having a globally unique id assigned by the logical network (uuid/ipv6=SRC) is managed by respective hypervisor (“SH”) and is attempting communication to VM2 with a physically associated address (“DIP”) and global ID (“uuid/ipv6=DST”) managed by its respective hypervisor (“DH”). As discussed above, control components in the NVI system can include the respective hypervisors of respective cloud providers where the hypervisors are specially configured to perform at least some of the functions for generating, maintaining, and/or managing communication in an NVI network. In other implementations, each hypervisor can be coupled with one or more proxy entities configured to work with respective hypervisors to provide the functions for generating, maintaining, and/or managing communication in the tenant network. The processes for executing communication policies (e.g., 900 and 1000) are discussed in some examples with reference to hypervisors performing operations, however, one should appreciate that the operations discussed with respect to the hypervisors can be performed by a control component, the hypervisors, and/or respective hypervisors and respective proxy entities.

According to one embodiment, the process 900 beings at 902 with SH intercepting a network packet generated by VM1, wherein the network packet includes physically associated addressing (to DIP). In some embodiments, the hypervisor SH and/or the hypervisor in conjunction with a proxy entity can be configured to capture communication events at 902. The communication event includes a communication initiated at VM1 address to VM2. The logical and/or physically associated addresses for each resource within the tenant's network can be retrieved, for example, by SH. In one example, a tenant database entry defines the tenant's network based on globally unique identifiers for each tenant resource (e.g., VMs) and their respective physically associated addresses (e.g., addresses assigned by respective cloud providers to each VM). In some embodiments, the tenant database entry also includes certificates and signatures for confirming mappings between global ID and physical addresses for each VM.

At 904, the tenant database can be accessed to look up the logical addressing for VM2 based on the physically associated address (e.g. DIP) in the communication event. Additionally, the validity of the mapping can also be confirmed at 906 using Cert(DST), Sign(DST, DIP), for example, as stored in the tenant database. If the mapping is not found and/or the mapping is not validated against the digital certificate, the communication event is terminated (e.g., the virtual communication cable VM1 is attempting to use is unplugged by the SH). Once a mapping is found and/or validated at 906, a system communication policy is checked at 908. In some embodiments, the communication policy can be defined by the tenant at part of creation of their network. In some implementations, the NVI system can provide default communication policies. Additionally, tenants can update and/or modify existing communication policies as desired. Communication policies may be stored in the tenant's entry in the NVI database or may be referenced from other data locations within the tenant network.

Each communication policy can be defined based on the global IDs assigned to communication partners. If for example, the communication policy specifies (SRC, DST: unplug), the communication policy prohibits communication between SRC and DST, 910 NO. At 912, the communication event is terminated. If for example, the communication policy permits communication between SRC and DST (SRC, DST: plug), SH can plug the unicast virtual cable between SRC and DST permitting communication at 914. The process 900 can also include additional but optional cryptographic steps. For example, once SH plugs the cable between SRC and DST, SH can initiate a cryptographic protocol (e.g., IPsec) with DH to provide cryptographic protection on application layer data in the network packet.

According to some embodiments, process 900 can be executed on all types of communication for the tenant network. For example, communication events can include VM to external address communication. In such an example DST is a conventional network identity rather than a global ID assigned to the logical network (e.g., an IP address). The communication policy defined for such communication can be defined based on a network edged policy for VM1. In some settings, the tenant can define a network edge policy for the entire network implement through execution of, for example, process 900. In additional settings, the tenant can define network edge policies for each VM in the tenant network.

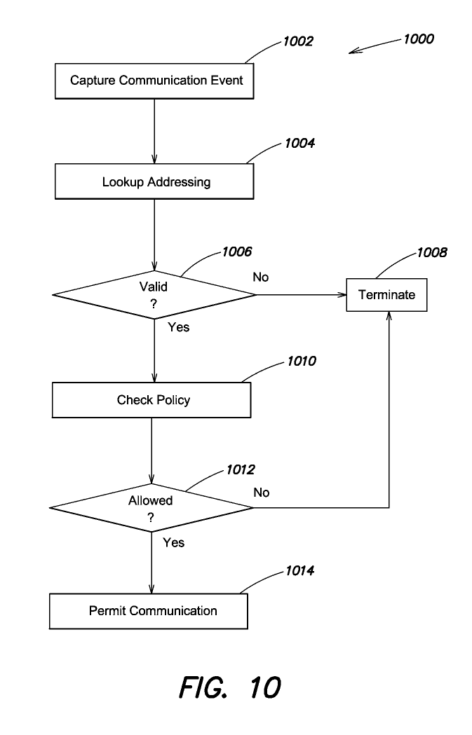

FIG. 10 illustrates another example execution of a communication policy within a tenant network. At execution of 1000 VM2 associated with a physically associated address (“DIP”) having a globally unique id assigned by the logical network (uuid/ipv6=DST) is managed by respective hypervisor (“DH”) and is receiving communication from VM1 with a physically associated address (“SIP”) and global ID (“uuid/ipv6=SRC”) managed by its respective hypervisor (“SH”).

At 1002, a communication event is captured. In this example, the communication event is the receipt of a message of a communication from VM1. The communication event can be captured by a control component in the NVI. In one example, the communication event is captured by DH. Once the communication event is captured, the logical addressing information for the communication can be retrieved. For example, the tenant's entry in the NVI database can be used to perform a lookup for a logical address for the source VM based on SIP within a communication packet of the communication event at 1004. At 1006, validity of the communication can be determined based on whether the mapping between the source VM and destination VM exist in the tenant's entry in the NVI DB, for example, as accessible by DH. Additionally, validity at 1006 can also be determined using certificates for logical mappings. In one example, DH can retrieve a digital certificate and signature for VM1 (e.g., Cert(SRC), Sign(SRC,SIP)). The certificate and signature can be used to verify the communication at 1006. If the mapping does not exist in the tenant database or the certificate/signature is not valid 1006 NO, then the communication event is terminated at 1008.

If the mapping exists and is valid 1006 YES, then DH can operate according to any defined communication policy at 1010. If the communication policy prohibits communication between SRC and DST (e.g., the tenant database can include a policy record “SRC, DST : unplug”) 1012 NO, then the communication event is terminated at 1008. If the communication is allowed 1012 YES (e.g., the tenant database can include a record “SRC, DST: plug”), then DH permits communication between VM1 and VM2 at 1014. In some examples, once DH determines a communication event is valid and allowed, DH can be configured to use a virtual cable between the communicating entities (e.g., VM1 and VM2). As discussed above with respect to process 900, additional cryptographic protections can be executed as part of communication between VM1 and VM2. For example, DH can execute cryptographic protocols (e.g., IPsec) to create and/or respond to communications of SH to provide cryptographic protection of application layer data in the network packets.

According to some embodiments, process 1000 can be executed on all types of communication for the tenant network. For example, communication events can include external to VM address communication. In such an example SRC is a conventional network identity rather than a global ID assigned to the logical network (e.g., an IP address). The communication policy defined for such communication can be defined based on a network edge policy for the receiving VM. In some settings, the tenant can define a network edge policy for the entire network implemented through execution of, for example, process 1000. In additional settings, the tenant can define network edge policies for each VM in the tenant network.

According to some embodiments, the tenant can define communication protocols for both senders and recipients, and firewall rules can be executed at each end of a communication over the logical tenant network.

### User Interface for Self Service Network Definition

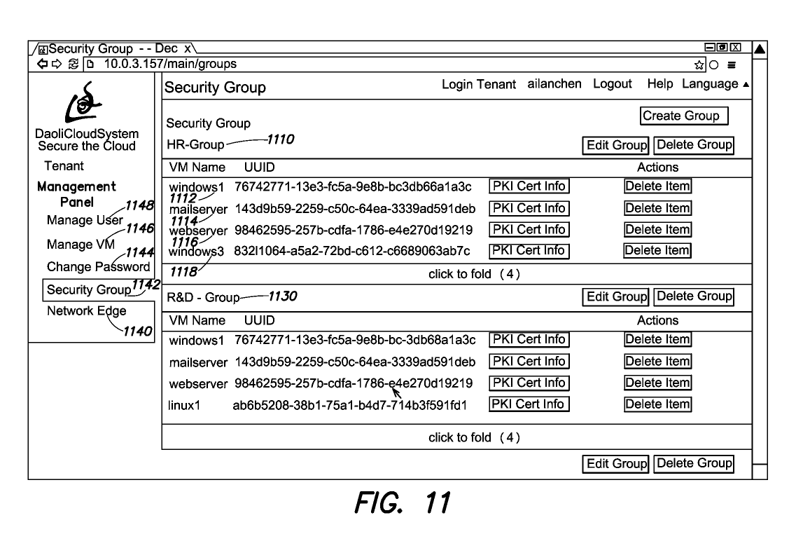

Shown in FIG. 11 is a screen shot of an example user interface 1100. The user interface (“UI”) 1100 is configured to accept tenant definition of network topology. In some embodiments, the user interface is configured to enable a tenant to add virtual resources (e.g., VMs) to security groups (e.g., at 1110 and 1130). The UI 1100 can be configured to allow the tenant to name such security groups. Responsive to adding a VM to a security group, the system creates and plugs virtual cables between the members of the security group. For example, VMs windows1 (1112), mailserver (1114), webserver (1116), and windows3 (1118) are members of the HR-Group. Each member has a unicast cable defining a connection between each other member of the group. In one example, for windows1 there is a respective connection for windows1 as a source to mailserver, webserver, and windows3 defined within HR-Group 1110. Likewise, virtual cables exist for R&D-Group 1130.

User interface 1100 can also be configured to provide other management functions. A tenant can access UI 1100 to define communication policies, including network edge policies at 1140, manage security groups by selecting 1142, password control at 1144, manage VMs at 1146 (including for example, adding VMs to the tenant network, requesting new VMs, etc.), and mange users at 1148.

According to some aspects, the communications protocol suite operates on communication inputs or addressing that is logical. For example, execution of communication in processes 900 and 1000 can occur using global IDs in the tenant network. Thus communication does not require any network location information about the underlying physical network. All physical associated addresses (e.g., IP addresses) which the tenant's rental VMs (the tenant's internal nodes) have temporary IP addresses assigned by respective provides. These temporary IP addresses are maintained in a tenant database, which can be updated as the VMs move, replicate, terminate, etc. (e.g., through execution of process 700). Accordingly, these temporary IP addresses play no role in the definition of the tenant's distributed logical network and firewall/communication policy in the cloud. The temporary IP addresses are best envisioned as pooled network resources. The pool networks resources are employed as commodities for use in the logical network, and may be consumed and even discarded depending on the tenant's needs. According to another aspect, the tenant's logical network is completely and thoroughly de-coupled from the underlying physical network. In such an architecture, software developed network functions can be executed to provide network QoS in simplified “if-then-else” style of high-level language programming. This simplification allows a variety of QoS guaranties to be implemented in the tenants' logical network. For example, QoS Network QoS which can be implemented as SDN programming at vNICs include: Traffic diversion, Load-balancing, Intrusion detection, DDoS scrubbing, among other options.

For example, an SDN task that the NVI system can implement can include automatic network traffic diversion. Various embodiments, of NVI systems/tenant logical networks distribute network traffic to the finest possible granularity: at the very spot of each VM making up the tenant network. If one uses such VMs to host web services, the network traffic generated by web services requests can be measured and monitored to the highest precision at each VM. When requests made to a given VM reach a threshold, the system can be configured to execute automatic replication of the VM and balance requests between the pair of VMs (e.g., the NVI system can request a new resource, replicate the responding VM, and create a diversion policy to the new VM). In one example, the system can automatically replicate an overburden or over threshold VM and new network requests can be diverted to the newly created replica.

Because the logic network over the NVI technology can have trans-datacenter distribution, such replicas can be created in a different datacenter to make the tenant network highly elastic in trans-datacenter scalability. In some implementations, new resources can be requested from cloud providers to advantageously locate the new resources.

As the NVI technology completely distributes network control policy to each VM, additional advantages can be realized in various embodiments. In particular any one or more of following advantages can be realized in various embodiments over conventional centralized deployment: (i) on-VM-spot unplug avoids sending/dropping packets to the central control points, and reducing network bandwidth; (ii) fine granularity distribution makes the execution of security policy less vulnerable to DDoS-like attacks; (iii) upon detect of DDoS-like attacks to a VM, moving the VM being attacked or even simply changing the temporary IP address can resolve the attack.

It is realized that the resulting logical network provides an intelligent layer-2 network or practically unlimited size (e.g., at 2̂128 level if the logical network is defined over IPv6 addresses) on cloud based resources. It is further realized that various implementations of the logical network manage communication without broadcast, as every transmission is delivered over a unicast cable between source and destination (e.g., between two VMs in the network). Thus, the NVI system and/or logical network solve a long felt but unsolved need for a large layer-2 network. By contrast, all previous technologies (overlay technologies) for constructing large scaled layer-2 network, e.g., TRILL, STT, VXLAN, NVGRE, resort to various protocol formulations of physical patching, i.e., combining, component logical networks which are defined over component switches and/or switches over routers. These previous overlay technologies all involve protocol negotiations among component logical networks over their respective underlying component physical networks, and hence inevitably involve physical attributes of the underlying physical networks. They are complex, inefficient, are very difficult to be inter-operable past different cloud operators, and consequently very hard to form a cloud network standard. The NVI-based new overlay technology in this disclosure is the world first overlay technology which uses the global management and global mapping intelligence of hypervisors and DBs formed infrastructure to achieve for the first time a practically unlimited size, globally distributed logical network, without need of protocol negotiation among component networks. The NVI-based overlay technology enables simple web-service controllable and manageable inter-operability for constructing a practically unlimited large scale and on-demand elastic cloud network.

### Testing Examples

Network bandwidth tests have been executed and compared in the following two cases:

1) Two VMs which are plugged with a unicast cable using embodiments of the NVI technology, and

2) Two VMs which are allowed to communicate under the conventional packet filtering technique ebtables, which is the well-known Linux Ethernet bridge firewall technique.

In both cases, the two pairs of VMs (4 VMs) are running on the same VMM on the same hardware server. Table 1 below provides network traffic measurements in three instances of comparisons, which are measured by the known tool NETPERF. The numbers shown in the table are in megabits (10̂6) per second.

TABLE 1

| | | | |
|---|---|---|---|
| VI | 25.44 | 25.49 | 24.70 |
| Ebtables | 25.80 | 24.45 | 25.26 |

There is no perceivable difference in network bandwidths between a firewall in the NVI plug/unplug unicast cable technology, and the conventional Linux Ethernet bridge firewall technology. One should realize that the comparison has been executed on plug-cable/pass-packets. It is expected that if the comparison was executed on operations including unplug-cable/drop-packets, then the difference is traffic would be greater, and would increase as the number of VMs rented by a tenant increases. In conventional approaches, the packet drop will take place in a centralized network edge point. In for example an OpenFlow consolidated logical switch, the packets drop must take place behind the consolidated switch, and that means, the firewall edge point to drop packets can be quite distant from the message sending VM, which translates to a large amount of wasted network traffic in the system.

Various embodiments also provide: virtual machines that each have PKI certificates; thus, not only can the ID of the VM get crypto quality protection, but also the VM's IP packets and IO storage blocks can be encrypted by the VMM. In one example, the crypto credential of a VM's certificate is protected and managed by the VMM and the crypto mechanisms, which manage VM credentials are in turn protected by a TPM of the physical server. Further embodiments provide for vNIC of a VM that never need to change its identity (i.e., the global address in the logical network does not change, even when the VM changes location, and even when the location change is in trans-datacenter). This results in network QoS programming at a vNIC that can avoid VM location changing complexities. By contrast, packet metadata processing in a switch (whether software or hardware or consolidated one like an OpenFlow switch) inevitably involve the location complexities. As discussed, NVI systems and logical network implementations provide load-balancing, traffic diversion, intrusion detection, DDoS scrubbing, and the like network QoS tasks, as simplified, SDN programming at vNICs. In some examples, a global ID used in the tenant network can include an IPv6 address.

### Example Implementation of Tenant Programmable Trusted Network

According to one embodiment, a cloud datacenter (1) runs a plural number of network virtualization infrastructure (NVI) hypervisors, and each NVI hypervisor hosts a plural number of virtual machines (VMs) which are rented by one or more tenants. Each NVI hypervisor also runs a mechanism for public-key based crypto key management and for the related crypto credential protection. This key-management and credential-protection mechanism cannot be affected or influenced by any entity in any non-prescribed manner. The in-NVI-hypervisor key-management and credential-protection mechanism can be implemented using known approaches, e.g., in the U.S. patent application Ser. No. 13/601,053, which claims priority to Provisional Application No. 61530543, which application is incorporated herein by reference in its entirety. Additional known security approaches include the Trusted Computing Group technology and TXT technology of Intel. Thus, the protection on the crypto-credential management system can be implemented even against a potentially rogue system administrator of the NVI.

2) In one embodiment, the NVI uses the key-management and credential-protection mechanism to manage a public key and protect the related crypto credential for a VM: Each VM has an individually and distinctly managed public key, and also has the related crypto credential so protected.
3) According to one embodiment, the NVI executes known cryptographic algorithms to protect the network traffic and the storage input/output data for a VM: Whenever the VM initiates a network sending event or a storage output event, the NVI operates an encryption service for the VM, and whenever the VM responds to a network receiving event or a storage input event, the NVI operates a decryption service for the VM.
4) In one embodiment, the network encryption service in (3) uses the public key of the communication peer of the VM; and the storage output encryption service in (3) uses the public key of the VM; both decryption services in (3) use the protected crypto credential that the NVI-hypervisor protects for the VM.
5) According to one embodiment, if the communication peer of the VM in (4) does not possess a public key, then the communication between the VM and the peer should route via a proxy entity (PE) which is a designated server in the datacenter. The PE manages a public key and protects the related crypto credentials for each tenant of the datacenter. In this case of (5), the network encryption service in (3) shall use a public key of the tenant which has rented the VM. Upon receipt of an encrypted communication packet from an NVI-hypervisor for a VM, the PE will provide a decryption service, and further forward the decrypted packet to the communication peer which does not possess a public key. Upon receipt of an unencrypted communication packet from the no-public-key communication peer to the VM, the PE will provide an encryption service using the VM's public key.
6) In one embodiment, the NVI-hypervisor and PE provide encryption/decryption services for a tenant using instructions in a whitelist which is composed by the tenant. The whitelist contains (i) public-key certificates of the VMs which are rented by the tenant, and (ii) the ids of some communication peers which are designated by the tenant. The NVI-hypervisor and PE will perform encryption/decryption services only for the VMs and communication peers which have public-key certificates and/or ids listed in the tenant's whitelist.
7) In one embodiment, a tenant uses the well-known web-service CRUD (create, retrieve, update, or delete) to compose the whitelist in (6). A tenant may also compose the whitelist using any other appropriate interface or method. Elements in the whitelist are the public-key certificates of the VMs which are rented by the tenant, and the ids of the communication peers which are designated by the tenant. The tenant uses this typical web-service CRUD manner to compose its whitelist. The NVI-hypervisor and PE use the tenant-composed whitelist to provide encryption/decryption services. In this way, the tenant achieves instructing the datacenter in a self-servicing manner to define, maintain and manage a virtual private network (VPN) for the VMs it rents and for the communication peers it designates for its rental VMs.
8) According to one embodiment, for the VMs which are rented by a tenant T, the PE can periodically create a symmetric conference key for T, and securely distribute the conference key to each NVI-hypervisor which hosts the VM(s) of T. The cryptographically protected secure communications among the VMs, and those between the VMs and the PE in (3), (5) and (6) can use symmetric encryption/decryption algorithms and the conference key. The secure distribution of the conference key from PE to each NVI-hypervisor can use the public key of each VM which is managed by the underlying NVI-hypervisor in (1) and (2). Upon receipt of the conference key, each NVI-hypervisor secures it using its crypto-credential protection mechanism in (1) and (2).

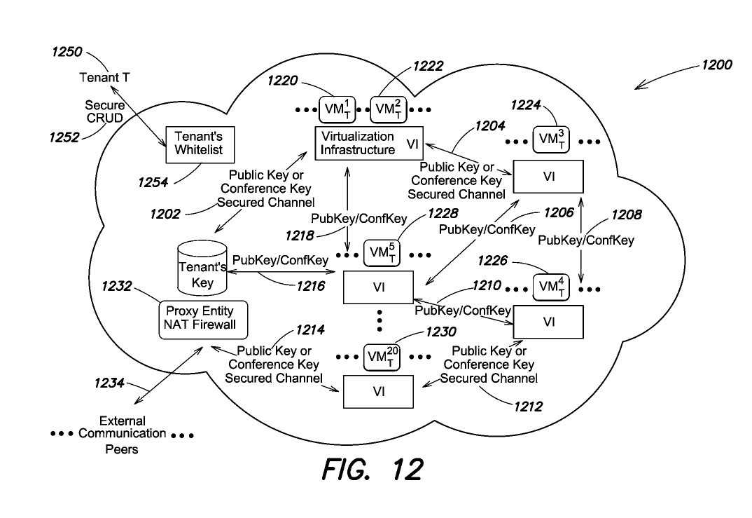

Shown in FIG. 12 is an example embodiment of a tenant programmable trusted network 1200. FIG. 12 illustrates both cases of the tenant T's private communication channels (e.g. 1202-1218) among its rental VMs (e.g., 1220-1230) and the PE (e.g., 1232). These communication channels can be secured either by the public keys of the VMs involved, or by a group's conference key. Shown in this example are 20 VMs rented by a tenant 1250. As shown, the tenant 1250 can define their trusted network using the known CRUD service 1252. In one example, the tenant uses the CRUD service to define a whitelist 1254. The whitelist can include a listing for identifying information on each VM in the tenant network. The whitelist can also include public-key certificates of the VMs in the tenant network, and the ids of the communication peers which are designated by the tenant. In some embodiments, the PE 1232 further provides functions of NAT (Network Address Translation) and firewall, as shown. In the embodiment illustrated, the PE can be the external communications facing interface 1234 for the virtual network.

According to some aspects, a VM in the trusted tenant network can only communicate or input/output data necessarily and exclusively via the communication and storage services which are provided by its underlying NVI-hypervisor. Thus, there can be no any other channel or route for a VM to bypass its underlying NVI-hypervisor to attempt to achieve or bypass communication and/or input/output data with any entity outside the VM. The NVI-hypervisor cannot be bypassed to perform encryption/decryption services for the VMs according to the instructions provided by the tenant. The non-bypassable property can be implemented via known approaches (e.g., by using VMware's ESX, Citrix's Xen, Microsoft's Hyper-V, Oracle's VirtualBox, and open source community's KVM, etc, for the underlying NVI technology).

Various embodiments achieve a tenant defined, maintained, and managed virtual private network in a cloud datacenter. In some examples, the tenant defines their network by providing information on their rental VMs. The tenant can maintain and managing the whitelist for its rental VMs through the system. The tenant network is implemented such that network definition and maintain can be done in a self-servicing and on-demand manner.

Various embodiments, provide for very low-cost Virtual Private Cloud (VPC) for arbitrarily small sized tenants. For example, a large number of small tenants can now securely share network resources of the hosting cloud, e.g., share a large VLAN of the hosting cloud which is low-cost configured by the datacenter, which in some examples can be executed and/or managed using SDN technology. Accordingly, the small tenant does not need to maintain any high-quality onsite IT infrastructure. The tenant now uses purely on-demand IT.

As the public-key certificates can be globally defined, the VPC provisioning methods discussed are also globally provisioned, i.e., a tenant is not confined to renting IT resources from one datacenter. Therefore, the various aspect and embodiments, enable break tradition vendor-locked-in style of cloud computing and provide truly open-vendor global utilities.

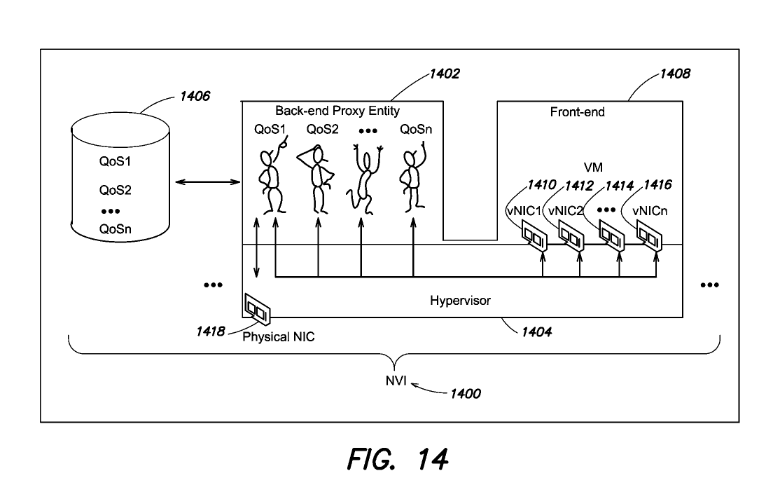

Shown in FIG. 14 is an example logical network 1400. According to one embodiment, a proxy entity 1402 is configured to operate in conjunction with a hypervisor 1404 of a respective cloud according to any QoS definitions for the logical network (e.g., as stored in database 1406). The three dots indicate that respective proxy entities and hypervisors can be located throughout the logical network to handle mapping and control of communication. For example, proxy entities and/or hypervisors can manage mapping between logical addresses of vNICs (1410-1416) and underlying physical resources managed by the hypervisor (e.g., physical NIC 1418), mapping between logical addresses of VMs, and execute communication control at vNICs of the front-end VMs (e.g., 1410-1416). In one embodiment, mapping enables construction of an arbitrarily large, arbitrary topology, trans-datacenter layer-2 logical network (i.e., achieved the de-coupling of physical addressing). In another embodiment, control enables programmatic communication control, or in other words achieves a SDN.

According to one embodiment, the proxy entity 1402 is a specialized virtual machine (e.g. at respective cloud providers or respective hypervisors) configured for back end servicing.

In some examples, a proxy entity manages internal or external communication according to communication policy defined on logical addresses of the tenants' isolated network (e.g., according to network edge policy). In other embodiment, the proxy entity executes the programming controls on vNICs of an arbitrary number of front end VMs (e.g., 1408). The proxy entity can be configured to manage logical mappings in the network, and to update respective mappings when the hypervisor assigns new physical resources to front end VMs (e.g., 1408).

As discussed above, various aspects and functions described herein may be implemented as specialized hardware or software components executing in one or more computer systems or cloud based computer resources. There are many examples of computer systems that are currently in use. These examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Further, aspects may be located on a single computer system, may be distributed among a plurality of computer systems connected to one or more communications networks, or may be virtualized over any number of computer systems.

For example, various aspects and functions may be distributed among one or more computer systems configured to provide a service to one or more client computers, or to perform an overall task as part of a distributed system or a cloud based system. Additionally, aspects may be performed on a client-server or multi-tier system that includes components distributed among one or more server systems that perform various functions, and may be distributed through a plurality of cloud providers and cloud resources. Consequently, examples are not limited to executing on any particular system or group of systems. Further, aspects and functions may be implemented in software, hardware or firmware, or any combination thereof. Thus, aspects and functions may be implemented within methods, acts, systems, system elements and components using a variety of hardware and software configurations, and examples are not limited to any particular distributed architecture, network, or communication protocol.

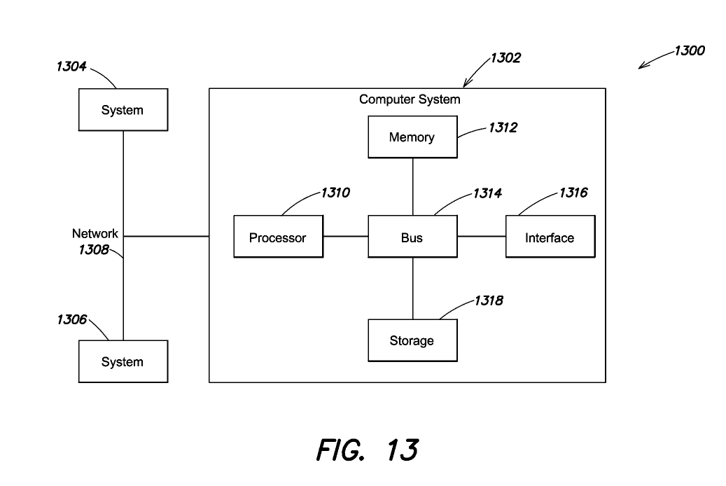

Referring to FIG. 13, there is illustrated a block diagram of a distributed computer system 1300, in which various aspects and functions are practiced. As shown, the distributed computer system 1300 includes one or more computer systems that exchange information. More specifically, the distributed computer system 1300 includes computer systems 1302, 1304 and 1306. As shown, the computer systems 1302, 1304 and 1306 are interconnected by, and may exchange data through, a communication network 1308. For example, components of an NVI-hypervisor system, NVI engine, can be implemented on 1302, which can communicate with other systems (1304-1306), which operate together to provide the functions and operations as discussed herein. In one example, system 1302 can provide functions for request and managing cloud resources to define a tenant network execution on a plurality of cloud providers. Systems 1304 and 1306 can include systems and/or virtual machines made available through the plurality of cloud providers.

In some embodiments, system 1304 and 1306 can represent the cloud provider networks, including respective hypervisors, proxy entities, and/or virtual machines the cloud providers assign to the tenant. In other embodiments, all systems 1302-1306 can represent cloud resources accessible to an end user via a communication network (e.g., the Internet) and the functions discussed herein can be executed on any one or more of systems 1302-1306. In further embodiments, system 1302 can be used by an end user or tenant to access resources of an NVI-hypervisor system (for example, implemented on at least computer systems 1304-1306). The tenant may access the NVI system using network 1308.

In some embodiments, the network 1308 may include any communication network through which computer systems may exchange data. To exchange data using the network 1308, the computer systems 1302, 1304 and 1306 and the network 1308 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS13, JSON, SOAP, CORBA, REST and Web Services. To ensure data transfer is secure, the computer systems 1302, 1304 and 1306 may transmit data via the network 1308 using a variety of security measures including, for example, TLS, SSL or VPN. While the distributed computer system 1300 illustrates three networked computer systems, the distributed computer system 1300 is not so limited and may include any number of computer systems and computing devices, networked using any medium and communication protocol.

As illustrated in FIG. 13, the computer system 1302 includes a processor 1310, a memory 1312, a bus 1314, an interface 1316 and data storage 1318. To implement at least some of the aspects, functions and processes disclosed herein, the processor 1310 performs a series of instructions that result in manipulated data. The processor 1310 may be any type of processor, multiprocessor or controller. Some exemplary processors include commercially available processors such as an Intel Xeon, Itanium, Core, Celeron, or Pentium processor, an AMD Opteron processor, a Sun UltraSPARC or IBM Power5+ processor and an IBM mainframe chip. The processor 1310 is connected to other system components, including one or more memory devices 1312, by the bus 1314.

The memory 1312 stores programs and data during operation of the computer system 1302. Thus, the memory 1312 may be a relatively high performance, volatile, random access memory such as a dynamic random access memory (DRAM) or static memory (SRAM).

However, the memory 1312 may include any device for storing data, such as a disk drive or other non-volatile storage device. Various examples may organize the memory 1312 into particularized and, in some cases, unique structures to perform the functions disclosed herein. These data structures may be sized and organized to store values for particular data and types of data. In some embodiments, each tenant can be associated with a data structured for managing information on a respective tenant network. The data structure can include information on virtual machines assigned to the tenant network, certificates for network members, globally unique identifiers assigned to the network members, etc.

Components of the computer system 1302 are coupled by an interconnection element such as the bus 1314. The bus 1314 may include one or more physical busses, for example, busses between components that are integrated within the same machine, but may include any communication coupling between system elements including specialized or standard computing bus technologies such as IDE, SCSI, PCI and InfiniBand. The bus 1314 enables communications, such as data and instructions, to be exchanged between system components of the computer system 1302.

The computer system 1302 also includes one or more interface devices 1316 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 1302 to exchange information and to communicate with external entities, such as users and other systems.

The data storage 1318 includes a computer readable and writeable nonvolatile, or non-transitory, data storage medium in which instructions are stored that define a program or other object that is executed by the processor 1310. The data storage 1318 also may include information that is recorded, on or in, the medium, and that is processed by the processor 1310 during execution of the program. More specifically, the information may be stored in one or more data structures specifically configured to conserve storage space or increase data exchange performance.

The instructions stored in the data storage may be persistently stored as encoded signals, and the instructions may cause the processor 1310 to perform any of the functions described herein. The medium may be, for example, optical disk, magnetic disk or flash memory, among other options. In operation, the processor 1310 or some other controller causes data to be read from the nonvolatile recording medium into another memory, such as the memory 1312, that allows for faster access to the information by the processor 1310 than does the storage medium included in the data storage 1318. The memory may be located in the data storage 1318 or in the memory 1312, however, the processor 1310 manipulates the data within the memory, and then copies the data to the storage medium associated with the data storage 1318 after processing is completed. A variety of components may manage data movement between the storage medium and other memory elements and examples are not limited to particular data management components. Further, examples are not limited to a particular memory system or data storage system.

Although the computer system 1302 is shown by way of example as one type of computer system upon which various aspects and functions may be practiced, aspects and functions are not limited to being implemented on the computer system 1302 as shown in FIG. 13. Various aspects and functions may be practiced on one or more computers having different architectures or components than that shown in FIG. 13. For instance, the computer system 1302 may include specially programmed, special-purpose hardware, such as an application-specific integrated circuit (ASIC) tailored to perform a particular operation disclosed herein. While another example may perform the same function using a grid of several general-purpose computing devices (e.g., running MAC OS System X with Motorola PowerPC processors) and several specialized computing devices running proprietary hardware and operating systems.

The computer system 1302 may be a computer system or virtual machine, which may include an operating system that manages at least a portion of the hardware elements included in the computer system 1302. In some examples, a processor or controller, such as the processor 1310, executes an operating system. Examples of a particular operating system that may be executed include a Windows-based operating system, such as, Windows NT, Windows 2000 (Windows ME), Windows XP, Windows Vista, Windows 13 or 8 operating systems, available from the Microsoft Corporation, a MAC OS System X operating system available from Apple Computer, one of many Linux-based operating system distributions, for example, the Enterprise Linux operating system available from Red Hat Inc., a Solaris operating system available from Sun Microsystems, or a UNIX operating systems available from various sources. Many other operating systems may be used, and examples are not limited to any particular operating system.

The processor 1310 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, C# (C-Sharp), Objective C, or Javascript. Other object-oriented programming languages may also be used. Alternatively, functional, scripting, or logical programming languages may be used.

Additionally, various aspects and functions may be implemented in a non-programmed environment, for example, documents created in HTML, XML or other format that, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements, e.g., specialized hardware, virtualized hardware, executable code, data structures or data objects, that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

1. A system for managing a logical network operating in a cloud compute environment, the system comprising:
at least one processor operatively connected to a memory;
a network virtualization infrastructure (NVI) component, executed by the at least one processor, configured to:
manage communication between a plurality of virtual machines;
assign globally unique logical identities to the plurality of virtual machines;
map, for each virtual machine, a respective globally unique logical identity to a physically associated network address; and
control communication within the logical network according to the globally unique logical identities.

2. system according to claim 1, wherein the NVI component is configured to map between the globally unique logical identities of the virtual machines having respective physically associated network addresses.

3. system according to claim 1, wherein the NVI component is configured to control communication within the logical network according to the globally unique logical identities at respective virtual network interface controllers (“vNICs”) of the plurality of virtual machines.

4. system according to claim 3, wherein the NVI component is configured to define logically unicast cables between pairs of vNICs of pairs of virtual machines in the plurality of virtual machines according to their globally unique logical identities.

5. system according to claim 1, wherein the system further comprises a database management system (DBMS) configured to store mappings between the globally unique logical identities of the plurality of virtual machines and physically associated addresses.

6. system according to claim 5, wherein the NVI component is configured to update a respective mapping stored by the DBMS between the globally unique logical identity and the physically associated network address in response to migration of a VM to a new location which has a new physically associated network address.

7. system according to claim 5, wherein the NVI component includes a plurality of hypervisors configured to control communication between the plurality of virtual machines according to mappings accessible through the DBMS.

8. system according to claim 1, wherein the NVI component includes a plurality of hypervisors and DBMS associated with at least one or a plurality of cloud providers.

9. system according to claim 8, wherein the plurality of hypervisors are configured to:
assign resources from respective cloud providers, wherein the plurality of hypervisors assign physically associated addresses for the resources; and
maintain mappings between the globally unique logical identities of the plurality of virtual machines and the physically associated addresses.

10. system according to claim 1, further comprising a network definition component configured to accept specification of a group of virtual machines to include in a tenant logical network.

11. system according to claim 10, wherein the network definition component is configured to accept tenant specified definition of the group of virtual machines, wherein tenant specified definition includes identifying information for the group of virtual machines to be included in the tenant logical network.

12. system according to claim 3, wherein the NVI component is configured to define an exclusive communication channel over a logical unicast cable for each pair of virtual machines of the plurality of virtual machines.

13. system according to claim 12, wherein the NVI component is configured to activate or de-activate the exclusive communication channel between the pair of virtual machines.

14. system according to claim 13, wherein the NVI component is configured to activate or de-activate the exclusive communication channel according to tenant defined communication policy.

15. system according to claim 14, wherein the tenant defined communication policy includes criteria for allowing or excluding communication over respective exclusive communication channels.

16. system according to claim 1, wherein the NVI component is configured to control external communication with the plurality of virtual machines at respective vNICs of the plurality of virtual machines.

17. system according to claim 1, wherein a system accessible communication policy can specify communication criteria for external communication.

18. system according to claim 1, wherein the NVI component is configured to manage communication between a plurality of virtual machines by managing physical communication pathways between a plurality of physically associated network addresses which are mapped to respective globally unique logical identities of the respective plurality of virtual machines,

19. system according to claim 18, wherein the mapping between the globally unique logical identities of the virtual machines and physically associated network addresses is configured to use physical network addresses of the NVI.

20. system according to claim 1, wherein the NVI component includes a plurality of hypervisors and respective proxy entities, wherein the plurality of hypervisors and the respective proxy entities are configured to manage the communication between the plurality of virtual machines.

21. system according to claim 20, wherein the respective proxy entities are configured to maintain mappings between the globally unique logical identities of the plurality of virtual machines and the physically associated addresses.

22. A computer implemented method for managing a logical network operating in a cloud compute environment, the method comprising:
managing, by a computer system, communication between a plurality of virtual machines;
assigning, by the computer system, globally unique logical identities to the plurality of virtual machines;
mapping, by the computer system, for each virtual machine, a respective globally unique logical identity to a physically associated network address; and
controlling, by the computer system, communication within the logical network according to the globally unique logical identities.

23. method according to claim 22, wherein controlling communication within the logical network according to the globally unique logical identities includes controlling communication at respective virtual network interface controllers (“vNICs”) of the plurality of virtual machines.

24. method according to claim 23, further comprising defining logically unicast cables between pairs of vNICs of pairs of virtual machines in the plurality of virtual machines according to their globally unique logical identities.

25. method according to claim 22, further comprising storing mappings between the globally unique logical identities of the plurality of virtual machines and physically associated addresses.

26. method according to claim 25, further comprising updating a respective mapping stored by the DBMS between the globally unique logical identity and the physically associated network address in response to migration of a VM to a new location which has a new physically associated network address.

27. method according to claim 25, wherein controlling, by the computer system, communication within the logical network according to the globally unique logical identities includes controlling, by a plurality of hypervisors, communication for the plurality of virtual machines according to the mappings.

28. method according to claim 22, wherein the computer system includes a plurality of hypervisors associated with at least one or a plurality of cloud providers.

29. method according to claim 28, wherein the method further comprises:
assigning, by the plurality of hypervisors, resources from respective cloud providers, including physically associated addresses for the resources; and
maintaining, by the plurality of hypervisors, mappings between the globally unique logical identities of the plurality of virtual machines and the physically associated addresses.

30. method according to claim 22, further comprising accepting specification of a group of virtual machines to include in a tenant logical network.

31-44. (canceled)
